(19) United States
(12) Patent Application Publication
(10) Pub. No.: US 2024/0383486 A1
(43) Pub. Date: Nov. 21, 2024

(54) SYSTEMS AND METHODS FOR UNCERTAINTY PREDICTION IN AUTONOMOUS DRIVING

(71) Applicant: TuSimple, Inc., SAN DIEGO, CA (US)

(72) Inventors: Patrik KOLARIC, San Diego, CA (US); Chunan HUANG, San Diego, CA (US); Junbo JING, San Diego, CA (US); Yufei ZHAO, San Diego, CA (US)

(21) Appl. No.: 18/664,793

(22) Filed: May 15, 2024

Related U.S. Application Data
(60) Provisional application No. 63/502,578, filed on May 16, 2023.

(51) Int. Cl. B60W 50/00; G06N 7/01; G06N 20/00

(52) U.S. Cl. CPC B60W 50/0097; G06N 7/01; G06N 20/00; B60W 2510/182; B60W 2520/10; B60W 2520/105

(57) ABSTRACT

Devices, systems, and methods for controlling a vehicle are described. An example method for controlling a vehicle includes obtaining planning information relating to an intended operation of the vehicle over a prediction horizon; inputting the planning information into an uncertainty model to determine uncertainty information, wherein: the uncertainty model is trained using sample driving event data based on a multivariate probability prediction algorithm; and the uncertainty model is configured to predict the uncertainty information that relates to a deviation of an operation of the vehicle according to an intended control instruction from the intended operation, the intended control instruction being determined based on the planning information; generating a control instruction based on the planning information and the uncertainty information; and operating the vehicle based on the control instruction.

### CROSS-REFERENCE TO RELATED APPLICATIONS

This application claims priority to and the benefit of U.S. Provisional Application No. 63/502,578, filed on May 16, 2023, the disclosure of which is incorporated herein by reference in its entirety.

### TECHNICAL FIELD

This document generally relates to autonomous driving.

### BACKGROUND

Autonomous vehicle navigation is a technology for sensing the position and movement of a vehicle and, based on the sensing, autonomously control the vehicle to navigate towards a destination. Autonomous vehicle control and navigation can have important applications in transportation of people, goods and services. Efficiently generating commands for the powertrain of a vehicle that enable its accurate control is paramount for the safety of the vehicle and its passengers, as well as people and property in the vicinity of the vehicle, and for the operating efficiency of driving missions.

### SUMMARY

One aspect of the present document relates to devices, systems, and methods for controlling a self-driving vehicle.

An example method for controlling a vehicle includes obtaining planning information relating to an intended operation of the vehicle over a prediction horizon; inputting the planning information into an uncertainty model to determine uncertainty information, wherein: the uncertainty model is trained using sample driving event data based on a multivariate probability prediction algorithm; and the uncertainty model is configured to predict the uncertainty information that relates to a deviation of an operation of the vehicle according to an intended control instruction from the intended operation, the intended control instruction being determined based on the planning information; generating a control instruction based on the planning information and the uncertainty information; and operating the vehicle based on the control instruction.

Another aspect of the present document relates to devices, systems, and methods for generating an uncertainty model based on a multivariate probability prediction algorithm.

Another aspect relates to an apparatus for controlling an autonomous vehicle. The apparatus includes one or more processors configured to implement any one or more methods disclosed herein.

Another aspect relates to one or more non-transitory computer-readable media that have code stored thereon; the code, upon execution by one or more processors, causes the one or more processors to implement any one or more of the methods described herein.

The above and other aspects and features of the disclosed technology are described in greater detail in the drawings, the description, and the claims.

### BRIEF DESCRIPTION OF THE DRAWINGS

FIG. 1 shows a block diagram of an example autonomous driving system 100 according to some embodiments of the present document.

FIG. 2 shows an example of a braking event in a vehicle according to some embodiments of the present document.

FIG. 3 exemplifies contributing factors including an environmental condition and adverse surface conditions, respectively, according to some embodiments of the present document.

FIG. 4 shows a process for operating a vehicle according to some embodiments of the present document.

FIG. 5 shows examples of onboard applications of an uncertainty model according to some embodiments of the present document.

FIG. 6 shows an example of generating a scheduled control sequence based on an input which includes planning information according to bounded tracking according to some embodiments of the present document.

FIG. 7A shows a process for generating an uncertainty model according to some embodiments of the present document.

FIG. 7B shows a process for generating a Gaussian process based uncertainty model according to some embodiments of the present document.

FIG. 7C shows an example configuration of an uncertainty model according to some embodiments of the present document.

FIG. 7D shows a flow of an example application of an uncertainty model according to some embodiments of the present document.

FIG. 7E shows uncertainty model training and application pipelines according to some embodiments of the present document.

FIG. 8A shows results of an example uncertainty model with respect to braking events according to some embodiments of the present document.

FIGS. 8B and 8C show predicted velocity and position deviations (or error) according to some embodiments of the present document.

FIG. 8D shows results of an uncertainty model with respect to braking events according to some embodiments of the present document.

FIG. 8E illustrates the validation results for 3 future time stamps (0.5 s, 1.5 s, 3.0 s) according to some embodiments of the present document.

FIG. 8F illustrates results of an online model validation according to some embodiments of the present document.

FIG. 9 shows an example of a hardware platform that can implement some methods and techniques described in the present document.

FIG. 10 illustrates a block diagram of an example vehicle ecosystem according to some embodiments of the present document.

Like reference numerals denote like components or operations.

### DETAILED DESCRIPTION

The transportation industry has been undergoing considerable changes in the way technology is used to control the operation of vehicles. As exemplified in the automotive passenger vehicle, there has been a general advancement towards shifting more of the operational and navigational decision making away from the human driver and into on-board computing power. This is exemplified in the extreme by the numerous under-development autonomous vehicles. Current implementations are in intermediate stages, such as the partially-autonomous operation in some vehicles (e.g., autonomous acceleration and navigation, but with the requirement of a present and attentive driver), the safety-protecting operation of some vehicles (e g, maintaining a safe following distance and automatic braking), the safety-protecting warnings of some vehicles (e.g., blind-spot indicators in side-view minors and proximity sensors), as well as ease-of-use operations (e.g., autonomous parallel parking).

Different types of autonomous vehicles have been classified into different levels of automation under the Society of Automotive Engineers' (SAE) J3016 standard, which ranges from Level 0 in which the vehicle has no automation to Level 5 (L5) in which the vehicle has full autonomy. In an example, SAE Level 4 (L4) is characterized by the vehicle operating without human input or oversight but only under select conditions defined by factors such as road type or geographic area. In order to achieve SAE L4 autonomy, vehicle control commands need to be efficiently computed while collaborating with both the high-level mission planner and the low-level powertrain characteristics and capabilities.

In existing autonomous and semi-autonomous systems, low-level powertrain control commands are typically generated to support adaptive cruise control (ACC), wherein the controller is designed to either maintain a constant driving speed on a highway or to follow a lead vehicle while maintaining a safe following distance between the vehicles. In such systems, the controller passively reacts to a control target and vehicle state situation, and the determination of vehicle actuation is driven by control errors. The control target normally only refers to a static driving speed in free cruise situations, or a dynamic driving speed determined only by the lead vehicle's instantaneous driving speed and the relative distance. In such cases, the control laws are normally designed to improve tracking accuracy, with other performance criteria being implicitly accounted for by control gain tuning. However, control gain tuning may inadvertently compromise tracking accuracy in some situations.

In addition, a tracking algorithm of an autonomous or semi-autonomous vehicle (or vehicle for brevity) that relies on a physical model may fail to capture some factors (environmental and non-environmental) that shape its dynamics. An adaptive tracking algorithm may alleviate this issue to some extent, but not completely, if it is limited to a predetermined or finite family of factors/regressors (e.g., speed\hat{ }2, torque, etc.) which may still overlook some relevant regressors needed to accurately represent the dynamics of the vehicle in some driving scenarios. For example, a delay between when an event has actually been accomplished (e.g., a coordinated movement of components in the braking system to achieve a braking event) and when the event is intended to occur according to planning information may exist due to, e.g., the time it takes for a coordinated movement of components to occur; however, such a delay may evade the tracking algorithm, thereby causing a deviation or discrepancy of the event that has actually occurred from as intended. This type of deviation or discrepancy may relate to missing knowledge of the system and may, in theory, be modeled deterministically, and may be referred to as epistemic uncertainty. On the other hand, aleatoric uncertainties are those that substantially cannot be built into a deterministic model. Some examples in the context of vehicle autonomy include external uncertainties (including, e.g., road bumps, varying road friction, adverse weather condition (e.g., wind gusts), or irrational behaviors of a vehicle or object operating in a vicinity of the vehicle of interest), internal uncertainties (including, e.g., peculiarities and/or wear of hardware (e.g., brake, engine), disturbing performance of one or more upstream modules) of a vehicle, or the like, or a combination thereof. For example, trajectory constraints employed at planning and control may need to accommodate brief false positives from perception and prediction modules and treat them as expected behavior.

Despite mature architecture and flexibility, a model based control framework may still be hard to tune in context of a fully autonomous technology (e.g., L4). It may be because the controller needs to be applicable for wide range of scenarios while maintaining robustness against both internal and external disturbances. Moreover, a number of factors impacting dynamics may be stochastic in nature. Therefore, attempt to build deterministic models that meet all the needs may be infeasible.

To solve these and other technical problems, embodiments of the present technology include systems and methods to model unknown regressors “jointly” along with aleatoric uncertainties by considering them as system uncertainty based on a non-parametric model. The model that predicts the performance of control task may be probabilistic by design in order to account for a wide range of factors that are hard to model explicitly. In some embodiments, Gaussian Process (GP) may be employed. The GP may be suitable for planning and/or control because it can model highly nonlinear functions while guaranteeing smoothness and capping its output by design (avoiding extreme values and jerky outputs). GP can run in real time even in context of low latency planning and control processes in autonomous driving. A GP model may be explainable, which is the beneficial property to consider when using machine learning models in safety related applications. In some embodiments, uncertainty information predicted according to some embodiments of the present document may be used to modify planning information generated by a mission planner, to build robustness against uncertain scenarios, e.g., in safety-critical scenarios on a highway or a local road including hard braking, a tight lane change, etc.

Embodiments of the disclosed technology are directed to systems and methods for autonomous driving. Some embodiments relate to the determination of control instructions for proper vehicle level actuation including, e.g. engine torque demand, foundation brake pressure demand, and engine brake torque demand, in order for the vehicle to operate along a path based on reference information (regarding, e.g., position s and/or speed v) provided by the upper stream kinematic control. Some embodiments of the present document include an uncertainty model configured to allow systematic and non-systematic uncertainties associated with planning information to be jointly assessed and applied in the determination of control instructions. Such uncertainties may be caused by context information. The context information may refer to a set of data and/or factors describing the state of the vehicle in an operation of the vehicle relating to or guided by reference information (e.g., mission waypoints). The context information may include the vehicle's current physical, operational, and environmental conditions. In some embodiments, the context information may include one or more contributing factors including, e.g., the state of the vehicle at a prior time point or position, the mechanical capacity of a portion of the vehicle (e.g., engine, brake), a road condition (e.g., slippery road, road bumps), wind gust, the behavior of a vehicle or object in a vicinity of the vehicle), an irregularity in an upstream glitch (e.g., in the planning module, in the perception module), or the like, or a change or a combination thereof. As discussed elsewhere in the present document, some contributing factors (e.g., wind gust, road bumps, upstream glitches) may be difficult or even infeasible to be assessed. For at least these considerations, the variety of internal and external disturbances (e.g., from their respective intended conditions) that L4 control module needs to support is large, building deterministic models that cover many or all circumstances independently may be infeasible. Moreover, a number of factors impacting dynamics are stochastic in nature. Therefore, embodiments of the present document provide an uncertainty model configured to predict the performance of control that is probabilistic in nature so as to account for a wide range of factors that are hard to model explicitly or directly. The uncertainty model may be scalable with respect to different contributing factors including, e.g., different road conditions, different levels of uncertainty promulgated from an upstream module (e.g., perception module, mission planning module), and/or difficult vehicle hardware (e.g., engine quality, brake quality).

According to some embodiments of the present document, the uncertainty model may model contributing factors jointly (indirectly) using expectation and standard deviation by lumping many contributing factors together into a small number of scalar probabilistic measures and therefore, scalable.

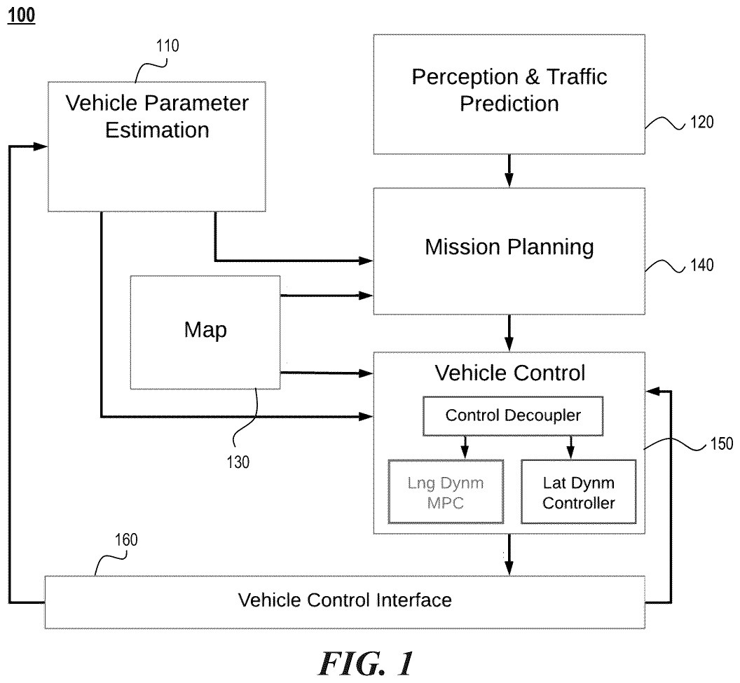

FIG. 1 shows a block diagram of an example autonomous driving system 100 that implements embodiments of the disclosed technology, which leverage the capabilities of model predictive control (MPC). As shown therein, an example autonomous driving system includes a vehicle parameter estimation module 110, a perception and traffic prediction module 120, a map module 130, a mission planning module 140, a vehicle control module 150, and a vehicle control interface 160. In some embodiments, the perception and traffic prediction module 120 can be configured to provide a context for driving situations, label the states of various nearby vehicles, identify instantaneous driving intentions, and predict future states of key neighboring vehicles. In some embodiments, the mission planning module 140 can be configured to use an abstracted ego vehicle motion model into the aforementioned driving situation context and generate an abstracted driving mission plan for a few seconds of time into the future, or referred to as a preview horizon or prediction horizon.

In some embodiments, the vehicle control module 150 includes a control decoupler that is operably connected to the lateral dynamic controller and the longitudinal dynamic MPC, which generate control commands that are transmitted to the powertrain of the vehicle via the vehicle control interface 160. In other embodiments, the vehicle control interface 160 may also be configured to feedback time-series data from the powertrain and other engine domain and wheel domain components to the vehicle parameter estimation module 110. The following description is provided with reference to a longitudinal motion control for illustration purposes, without the intention to be limiting. It is understood that the disclosed technology can be applied in lateral motion control.

Generating the vehicle control actuations is constrained by the mechanical capacity of various components of the vehicle including, e.g., the maximum actuation capability of the vehicle. In contrast to control systems designed for SAE L3 and below (e.g., driving assistance and semi-autonomous driving) that requires the driver to take responsibility when a motion abnormality occurs, the disclosed embodiments are configured to provide full vehicle motion safety liability. In some embodiments, this may be achieved by investigating the state reachability and motion feasibility of the control scenario and modulating the vehicle state proactively in a time-varying manner subject to vehicle state constraints required by the autonomous driving planner for safety (e.g., minimum or maximum vehicular speed, position, or acceleration). Because the control actuation is proactively scheduled for future driving missions with consequence projection, the described embodiments can dynamically allocate vehicle actuation resources for future challenging motion events (e.g., prematurely configuring a high horsepower output phase), thereby achieving better state constraint compliance than conventional passive error-driven controllers.

Merely by way of example, when an upper level state constraint exceeds the nominal actuation capability of the vehicle, the infeasible state constraint may be relaxed by a minimum amount while maximizing the vehicle actuation using slack variable techniques, which reduces the possible risk at the output of the corresponding system module. This capability of fully utilizing the vehicle's output to be compliant with any required motion constraint to the maximum extent is one of the advantages of the described embodiments compared to conventional autonomous driving capabilities.

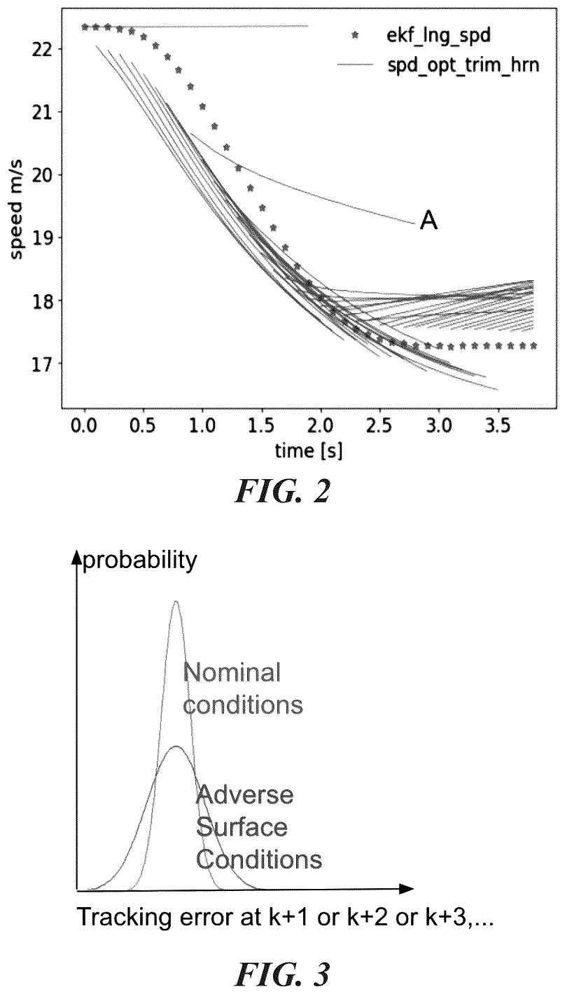

FIG. 2 shows an example of a braking event in a vehicle according to some embodiments of the present document. The solid lines indicate a planned (or intended) trajectory of speed (or velocity) at different time points during the braking event, while the solid dots show the actual speed at various time points. As illustrated, in a first phase at the beginning of the braking event when the time is close to zero, the speed of the vehicle indicated by the solid dots (denoted as “ekf_lng_spd”) is higher than planned or intended (or referred to as over delivery) indicated by the solid lines, while in a second phase at a later portion of the brake event, the speed of the vehicle is lower than intended (as indicated by the dots falling below the solid lines at corresponding time points (or referred to as under delivery). Curve A that stands out may constitute an outlier caused by, e.g., a glitch in an upper stream module. Accordingly, FIG. 2 illustrates a deviation of an actual speed trajectory from an intended speed trajectory. The deviation may be due to one or more contributing factors including, e.g., a delay in delivering the brake force compared to when it is intended to be delivered, wear of the brake plate or a tire, a shift in the performance of the engine over time, the weight of the vehicle, the condition of the road, or the like, or a combination thereof.

FIG. 3 exemplifies contributing factors including an environmental condition and the adverse surface conditions, respectively. According to some embodiments of the present document, uncertainty information with respect to planning information may be predicted and used, along with the planning information, in the determination of control instructions for operating the vehicle.

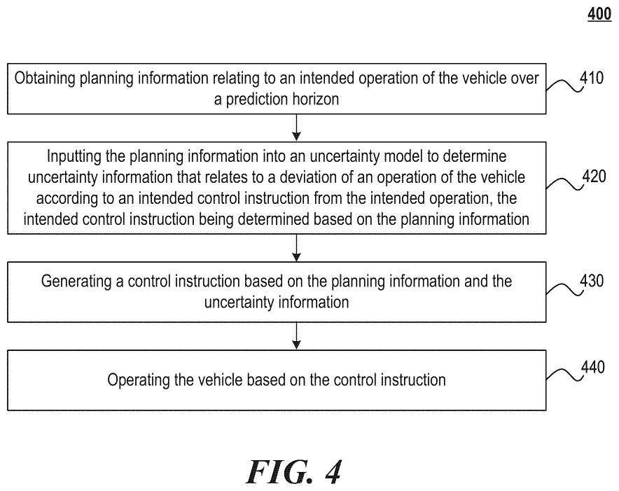

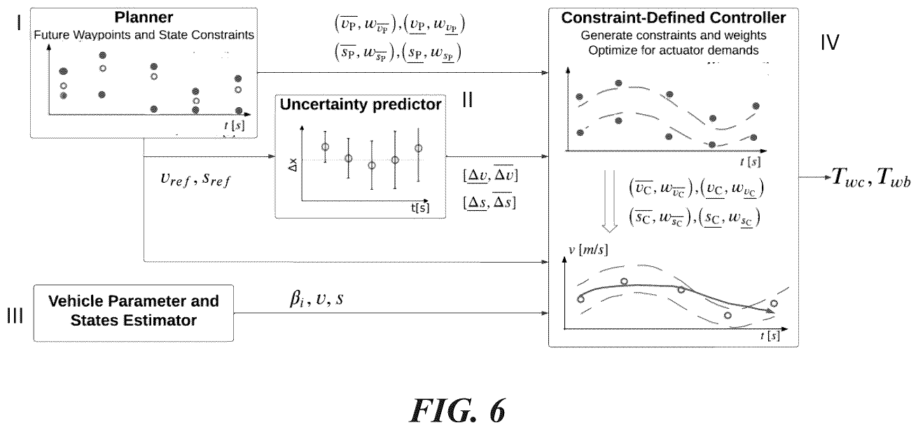

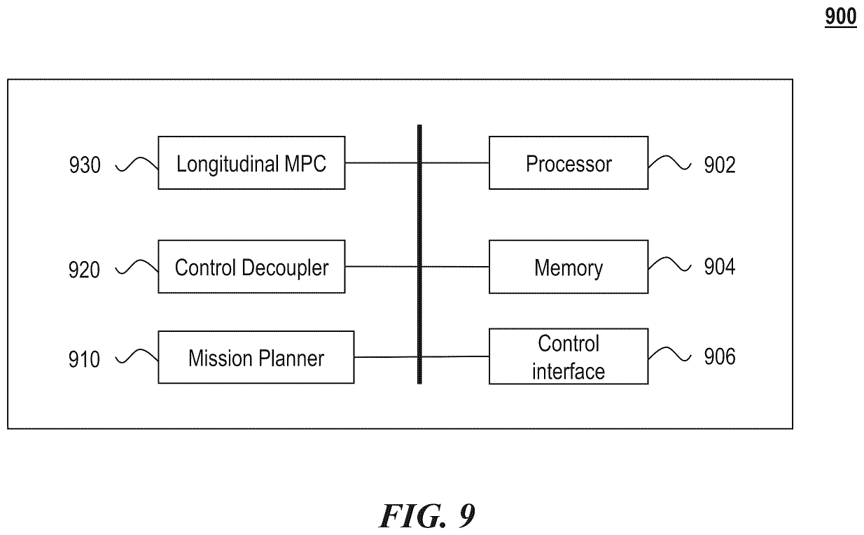

FIG. 4 shows a process 400 for operating a vehicle according to some embodiments of the present document. At 410, the process 400 may obtain planning information relating to an intended operation of the vehicle over a prediction horizon. In some embodiments, the planning information may be provided by an upstream module, e.g., the mission planning module 140 as illustrated in FIG. 1, planner as illustrated in panel I of FIG. 6, and mission planner 910 as illustrated in FIG. 9. In some embodiments, the planning information from a mission planner may be referred to as reference information. In some embodiments, the planning information may be determined by modifying the reference information based on state constraints (e.g., limitations on the mechanical capacities of the vehicle, or a portion thereof).

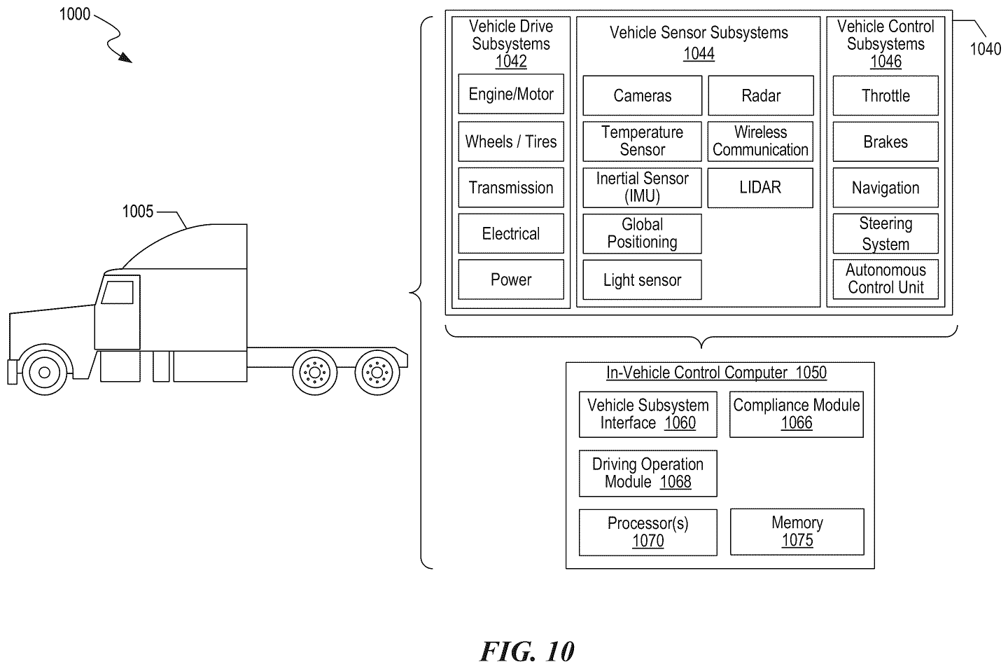

In some embodiments, an intended operation, or a planned operation, may refer to an operation of the vehicle if it operates perfectly as planned according to the planning information (e.g., without one or more contributing factors such as a delay in delivering or executing a control instruction, wind gusts, a random road bump, etc.). Based on the planning information, an intended control instruction may be determined. If the vehicle operates according to the intended control instruction, the operation may deviate from the intended operation due to the existence of one or more contributing factors including, e.g., a delay in delivering or executing the intended control instruction. At 420, by inputting the planning information into an uncertainty model (or referred to as an uncertainty predictor), the process 400 may determine uncertainty information. The uncertainty information may relate to the deviation of the operation according to the intended control instruction from the intended operation. At 430, the process may generate a control instruction based on the planning information and the uncertainty information. That is, the uncertainty information generated at 420 may be used as feedback to adjust the planning information to count for the uncertainty caused by one or more contributing factors jointly without parametrically or deterministically quantifying the one or more contributing factors. At 440, the process 400 may operate the vehicle according to the control instruction. For example, the vehicle control interface 160 as illustrated in FIG. 1 or the control interface 906 as illustrated in FIG. 9, or the vehicle control subsystems 1040 as illustrated in FIG. 10, may actuate one or more components of the vehicle (e.g., brake, engine) based on the control instruction to operate the vehicle.

In some embodiments, the planning information and the intended operation relate to a plurality of operation parameters of the vehicle. In some embodiments, the uncertainty information may include multiple deviation components each of which may relate to one of a plurality of operation parameters. In some embodiments, the plurality of operation parameters may include at least one of velocity, position, or acceleration of the vehicle.

In some embodiments, the uncertainty model may include a plurality of component uncertainty predictors each of which is configured to predict a deviation component of the uncertainty information for one of the plurality of operation parameters. In some embodiments, the uncertainty model may include a single model from which multiple deviation components may be output.

In some embodiments, the process 400 may further input a target confidence level, in addition to the planning information and the uncertainty information, into the uncertainty model to determine the uncertainty information. In some embodiments, the target confidence level may indicate a probability that the deviation of the operation of the vehicle according to the control instruction (e.g., the control instruction determined by taking into consideration the uncertainty information) from the intended operation falls within the uncertainty information.

In some embodiments, the process 400 may further input context information, in addition to the planning information and the uncertainty information, into the uncertainty model to determine the uncertainty information. In some embodiments, the context information may include at least one of a prior operation of the vehicle at a time point that precedes the prediction horizon, environmental information of an environment where the intended operation is to occur, or a known condition of the vehicle. Merely by way of example, the process 400 may further input current values of one or more operation parameters, in addition to the planning information and the uncertainty information, into the uncertainty model to determine the uncertainty information such that the process 400 may assess how much change the vehicle needs to make from the current status to a next status according to the planning information (or an intent of the control module).

In some embodiments, the uncertainty information determined by the uncertainty model may relate to at least one of a mechanical capacity of the vehicle, an irregularity in the vehicle or a portion thereof, a difference between the intended operation and a prior operation of the vehicle at a time point that precedes the prediction horizon, a magnitude or rate of change of the operation during the intended operation or a portion thereof, an environment where the intended operation is to occur, or an irregularity of the planning information. However, by employing the uncertainty model as described herein, multiple contributing factors may be considered jointly, obviating the need to consider them individually, which may be too expensive in terms of time or computational cost as described elsewhere in the present document.

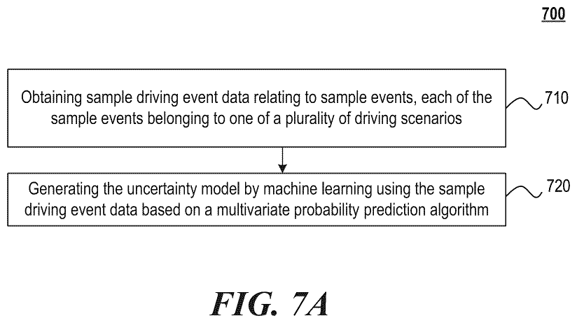

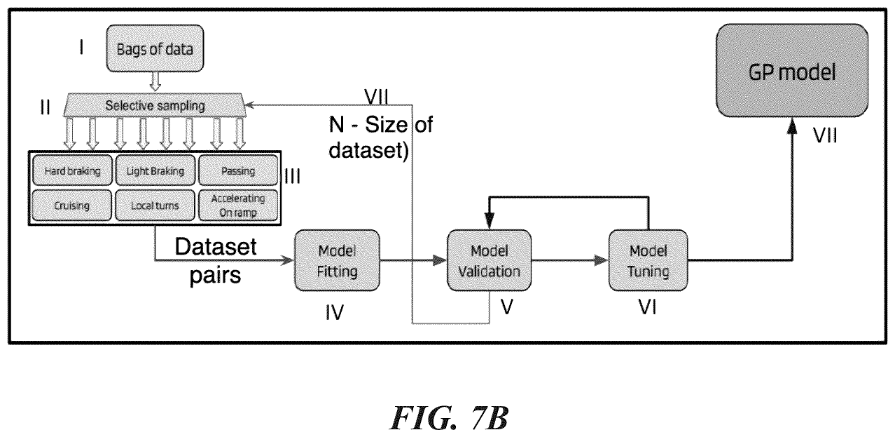

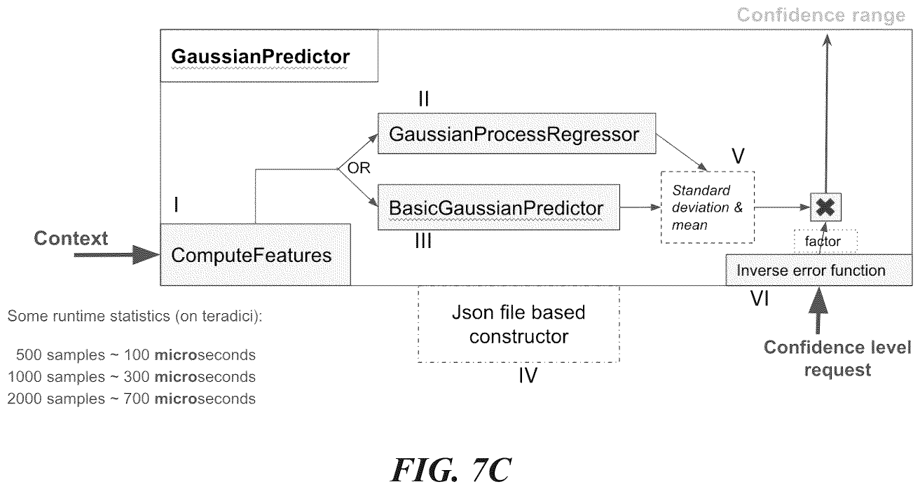

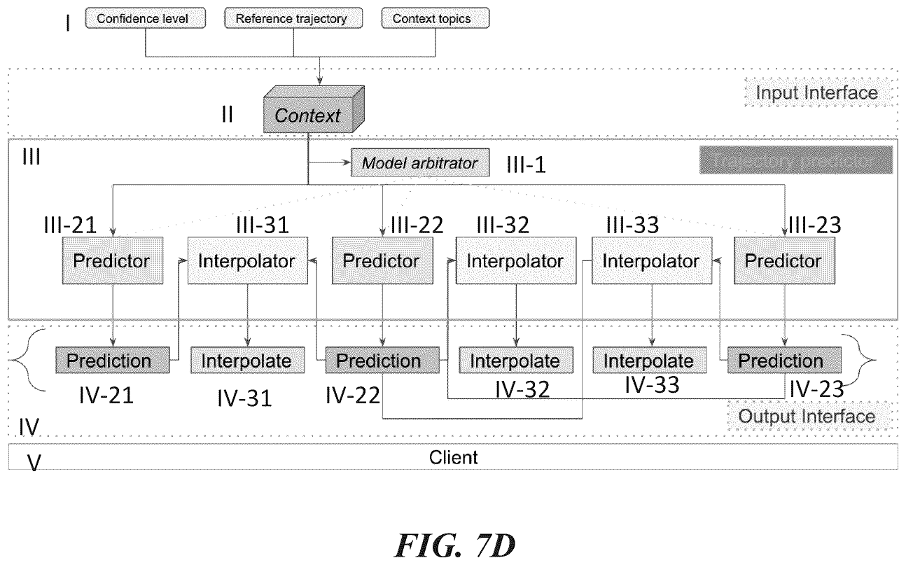

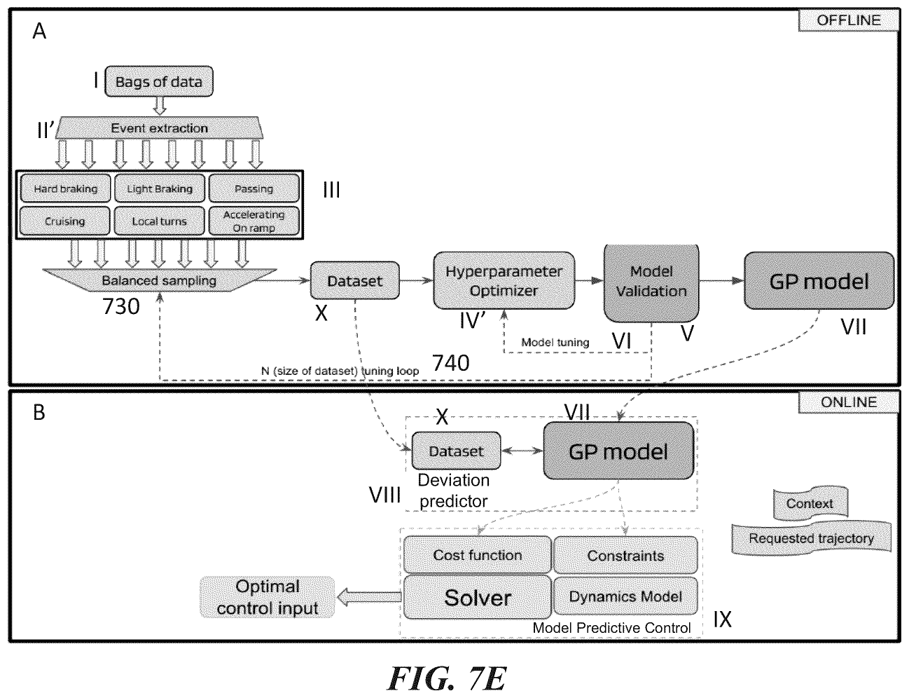

In some embodiments, the uncertainty model may be trained using sample driving event data based on a multivariate probability prediction algorithm. In some embodiments, the sample driving event data may relate to sample events. In some embodiments, each of the sample events may belong to one of a plurality of driving scenarios. In some embodiments, the plurality of driving scenarios may include at least one of light braking whose braking pressure is below a first brake pressure threshold, hard braking whose braking pressure is above a second brake pressure threshold, on-ramp acceleration, passing, cruising at a constant speed, front vehicle cut-in, or a turning whose angular velocity exceeds an angular velocity threshold. More description regarding the uncertainty model, and the training thereof, may be found elsewhere in the present document. See, e.g., FIGS. 7A-7D, and the description thereof. In some embodiments, the uncertainty model may be trained offline, and used online according to the process 400. In some embodiments, the uncertainty model may be updated shortly after (e.g., 30 seconds, 1 minute, 2minutes, 3 minutes, 5 minutes, 10 minutes, etc., after) an event occurs and event data becomes available such that the updated uncertainty model may become available for predicting uncertainty information during a subsequent portion of a same trip. In some embodiments, the uncertainty model may be updated offline periodically or when a certain amount of new training data becomes available.

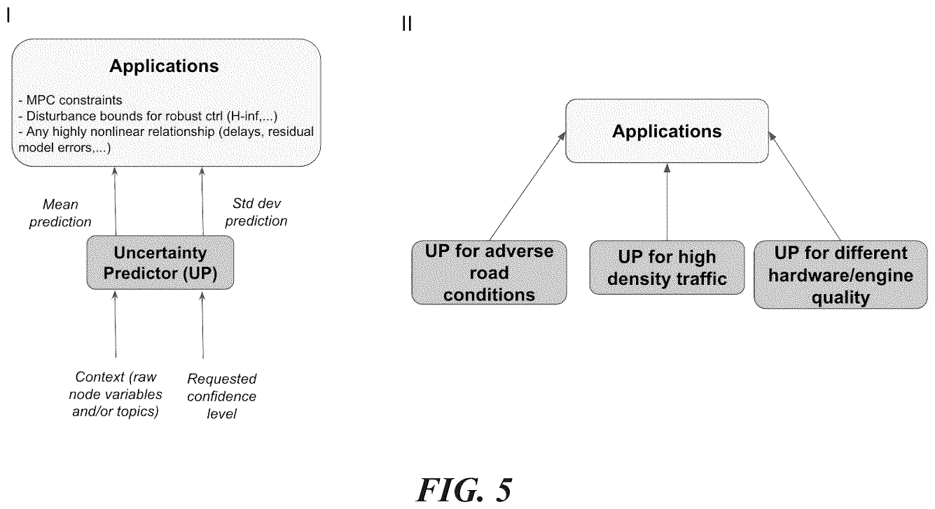

FIG. 5 shows examples of onboard applications of an uncertainty model according to some embodiments of the present document. Panel I of FIG. 5 shows that the input of an uncertainty model (referred to as an uncertainty predictor therein) may include context information. Example context information may include current values of one or more operation parameters (e.g., velocity, acceleration) at a current time point that precedes (immediately or further prior time points) a prediction horizon (one or more time points or waypoints) with respect to which planning is performed. The context information may also include planning information or an intended operation (described in terms of, e.g., a speed trajectory, position trajectory). Additionally or alternatively, the input of an uncertainty model may include a confidence level. In some embodiments, the confidence level may be specified by a user. In some embodiments, the confidence level may be set automatically, e.g., according to a system setting. The uncertainty model may provide a functional relationship between input and output, e.g., where a nonlinear relationship exists. For example, the uncertainty model may output a mean prediction and a standard deviation prediction. The mean prediction may be used, along with planning information, to determine an upper bound and a lower bound of an operation parameter. Example applications of the uncertainty model may include the determination of MPC constraints as illustrated in FIG. 6, the determination of disturbance bounds for robust control, etc. As illustrated in panel II of FIG. 5, uncertainties due to context information including adverse road conditions, high density traffic, different hardware or engine quality, etc., may be modeled using an uncertainty model as described herein.

FIG. 6 shows an example of generating a scheduled control sequence based on an input which includes planning information (e.g., reference future states or waypoints and state constraints) according to bounded tracking according to some embodiments of the present document. As illustrated, the input from the planner (e.g., mission planning module 140 in FIG. 1) includes a series of vehicle mission waypoints illustrated by the open circles in panels I and IV of FIG. 2C and the context information illustrated by the solid dots in panels I and IV of FIG. 2C. The vehicle mission waypoints may be in the form of reference speed (or referred to as reference velocity) and distance time sequences. The solid dots illustrating the context information in panels I and IV of FIG. 6 constitute pairs each of which describes a range defined by an upper bound and a lower bound (represented by two solid dots corresponding to a same time point) of the velocity (or referred to as speed) or distance corresponding to a reference value of the velocity or distance at a time point. The context information may include one or more state constraints and corresponding harshness levels the planner specifies. The state constraints of the context information specified by the planner may be referred to as planner constraints or control hard constraints described elsewhere in the present document. For example, the context information may include speed upper and lower constraints and their corresponding harshness levels, and/or distance (or position) upper and lower constraints and their corresponding harshness levels. In some embodiments, there may be none, one, or more of such constraints spanning the prediction horizon for each state (e.g., speed or position) and type (e.g., upper or lower) pair (e.g., a speed upper constraint, a speed lower constraint, speed upper and lower constraints, a distance upper constraint, a distance lower constraint, distance upper and lower constraints, etc.). The differences between the solid dots and their respective corresponding reference values may reflect one or more state constraints. A harshness level may be assigned based on one or more factors including, e.g., safety criticality of the corresponding boundary or boundaries. For example, a collision related constraint may be assigned with a higher harshness level than a comfort related constraint. A constraint with a lower harshness level may be violated when applicable than a constraint with a higher harshness level.

The reference information and context information may be input to an uncertainty predictor (e.g., an uncertainty model as described elsewhere in the present document) as illustrated in panel II of FIG. 6. The uncertainty predictor may utilize the reference information (e.g., the reference state sequences as illustrated by the open circles in panels I and IV of FIG. 6) and the context information (or referred to as the current vehicle state information as illustrated by the solid dots in panels I and IV of FIG. 6) for the preview horizon to estimate the distribution of deviations in states between modeled state sequences and the executed state sequences.

The uncertainty predictor may include a model trained offline. To account for variations of control delivery quality across different operating scenarios, multiple uncertainty models may be trained offline using diverse and/or balanced datasets. Such datasets may include those collected from road trips (e.g., past test trips), synthetic datasets generated by simulations, or the like, or a combination thereof. As used herein, a dataset being diverse may indicate that the dataset include data representing various operation scenarios or conditions (e.g., free cruising, following traffic, executing cut-in, merging, lane changing, accelerating on ramps, decelerating on off-ramps, etc.). As used herein, a dataset being balanced may indicate that the amounts of data representing different operation scenarios are comparable. For example, the amount of data representing the operation scenarios of following traffic may be comparable to the amount of data representing the operation scenarios of executing cut-ins. As used herein, comparable amounts of data may indicate that the data volumes representing different operational scenarios are of the same order of magnitude. Different uncertainty models may target different operating scenarios, such as on-ramp acceleration, cruising at constant speed and harsh braking events, for the control task to operate in.

During onboard uses, the operation condition may be evaluated to guide a selection of a suitable uncertainty model. Given a confidence level p, a state reference sequence and a current states, the uncertainty predictor may provide the range of deviations. This evaluation may be performed for both speed and position. Merely by way of example, both speed and position deviations may be modeled independently as multi-variate Gaussian distributions. Additional description of the generation of a scheduled control sequence based on an input which includes planning information may be found at, e.g., U.S. Provisional Application No. 63/502,571 filed May 16, 2023, and U.S. Patent Application No.______ (Attorney Docket No.: 128000.8259.US01), filed on even date, the contents of each of which are incorporated by reference.

The output of the uncertainty predictor may be input to a constraint-defined controller as shown in panel IV of FIG. 6. The dashed line in the upper figure in panel IV may be determined by moving the solid dots inward (closer to corresponding reference values or to a safer side) by the uncertainty degree at various time points and then connecting the moved solid dots. The dashed lines define a safe region. The safe region may be described as tolerable ranges of an operation parameter at various time points. Penalty weights may be determined based on a modulation bandwidth at each of various time points. In some embodiments, a modulation bandwidth corresponding a time point may indicate or relate to a difference between a tolerable range and a state constraint (e.g., a planner constraint as described elsewhere in the present document) at the time point of the plurality of time points. Based on the safe region in combination with one or more vehicle parameters (exemplified by Bᵢ and state estimator (represented using velocity v and position s), the constraint-defined controller may generate constraints and penalty weights (or weights for brevity) to optimize actuator demands (e.g., control commands) indicated by the solid line in the bottom figure in panel IV of FIG. 6. The penalty weights may be determined based on a modulation bandwidth at each of various time points, as described elsewhere in the present document. Based on the safe region in combination with one or more vehicle parameters (exemplified by Bᵢ and state estimator (represented using velocity v and position s), constraints and penalty weights (or weights for brevity), the constraint-defined controller may improve or optimize actuator demands (e.g., control commands) indicated by or corresponding to the solid line in the bottom figure in panel IV of FIG. 2C. The output of the constraint-defined controller may include the wheel domain torque (e.g., generated by engine combustion and engine coasting friction) Twc and the wheel brake torque Twb. More descriptions regarding bounded tracking may be found in U.S. Provisional Application No. 63/502,571, filed on May 16, 2023, and U.S. Application No.______ (Attorney Docket No.: 128000.8259.US001), filed on even date, the contents of each of which are incorporated by reference.

For illustration purposes, the development of an uncertainty model according to some embodiments of the present document is described with respect to a control task. The control task is described by introducing 1) the input interface with the upstream decision making task, and 2) the measures of operational quality of control task.

In the standard planning and control system design, given the upstream planner's trajectory request Vₜ=[vₜ¹, vₜ², . . . , vₜ^{T}] at time t with T steps in horizon, the MPC may solve optimal control command uₜ which, when applied at system actuators, may be expected to result in a trajectory that closely follows request V. Continuously applying uₜ over time may result in a trajectory delivery expressed as;

$$\tilde{V} = [ {\tilde{v}}_{t + 1} , {\tilde{v}}_{t + 2} , … , {\tilde{v}}_{t + T} ] . \qquad ( 1 )$$

The trajectory deviation may be defined as:

$${d}_{t} = \tilde{V} - {V}_{t} = [ {d}_{t}^{1} , {d}_{t}^{2} , … , {d}_{t}^{T} ] . \qquad ( 2 )$$

Accordingly, the measure of delivery quality may be a positive scalar function q(dₜ). For example, the delivery quality may be measured using any one of the following:

$$q ( {d}_{t} ) = {‖ {d}_{t} ‖}_{2} , \qquad ( 3 A )$$

$$q ( {d}_{t} ) = mean ( {d}_{t} ) , \qquad ( 3 B )$$

$$or$$

$$q ( {d}_{t} ) = RMSE ( {d}_{t} ) . \qquad ( 3 C )$$

The delivery quality of existing control algorithms may be sufficient to cover a subset of driving scenarios (also known as Operational Design Domains (ODD) in automotive industry). However, a pattern of lower delivery quality may appear in certain ODDs. As autonomous driving technology progresses towards maturity, the control task may need to perform consistently well over large variance of driving scenarios and thereby show unprecedented levels of robustness in quality q(dt). Moreover, such performance boundary and expected accuracy may need to be shared in upstream modules such as a planner, which may vary across different ODDs. The delivery quality variance over a wide spectrum of ODDs may root in at least some the design assumptions built into the dynamics model.

Longitudinal dynamics modeling may be employed in real world applications by estimating empirical correlations, which may be expressed as:

$${v}_{t} = {v}_{t - 1} + {α}_{1} ( G ) {T}_{e p} + {α}_{2} ( G ) {T}_{e b} + {α}_{3} {P}_{fb} + {α}_{4} {v}^{2} + {α}_{5} θ + {α}_{6} , \qquad ( 4 )$$

in which v is the vehicle longitudinal speed; Tₑₚ is the engine propulsion torque on the flywheel; T_{eb} is the engine brake torque generated from the retarder brake system; P_{fb} is the brake pressure from the foundation brake system; θ is the road grade of the vehicle's combined center of gravity (COG) location; αᵢ (i=1, . . . , 6) are coefficients that rate the impact of the aforementioned terms on vehicle longitudinal acceleration, where α₁(G) and α₂(G) show their dependence on discontinuous gear level G.

In reality, the coefficients αᵢ (i=1, . . . , 6) may absorb the static impactors (e.g., engine characteristics and quality), the slow varying impactors (e.g., vehicle mass) and the dynamic impactors (e.g., gear transmissions, road surface resistance, impact of wind gusts, etc.) some of which are discrete time events. The coefficients estimated from the data can absorb some of the impactors. However, the model accuracy may be limited by predetermined basis set of regressors (Tₑₚ, T_{eb}, P_{fb}, . . . ) which may be incomplete. Although missing regressors can be determined, authors argue that this is excessively complex undertaking in autonomous driving system due to a number of corner cases (ODDs) that the regression model needs to support. To make things worse, some impacting factors may be dynamic, discrete and/or stochastic in nature which makes it hard to capture them by adaptive data-driven regression. Accordingly, the substandard delivery quality as described may be a direct consequence of using a dynamics model that does not fully capture ODD.

To solve these and other problems, a data-driven modeling technique may be employed according to some embodiments of the present document. Such a data-driving modeling technique can predict the accuracy of control task in real time and with high confidence and accordingly supplement an existing control algorithm in rare and safety critical ODDs when the conventional delivery quality is consistently substandard.

A deterministic full state model of vehicle dynamics may be given as:

$${x}_{k + 1} = f ( {x}_{k} , {u}_{k} ( {x}_{k} ) ) , \qquad ( 5 )$$

where xₖ is a full set of both observable and unobservable impacting factors and uₖ is the MPC input.

The deterministic part of the output equation may be given as:

$${v}_{k} = h ( {x}_{k} ) . \qquad ( 6 )$$

The trajectory deviation may depend causally on the impacting factors, and accordingly may be expressed as a sample from an unknown distribution:

$${d}_{t} ∼ p ( {d}_{t} \vert {x}_{t - T} , … {x}_{t - K} ) = ( {d}_{t} \vert {x}_{t} ) , \qquad ( 7 )$$

where xₜ=x_{t-T}, . . . , x_{t-K} is for convenience of notation. The unknown distribution in equation (7) can be learned from data under some mild assumptions.

In some embodiments, Gaussian Process modeling may be employed to determine the unknown distribution in equation (7). For a dataset includes a finite set N training pairs, (dₜ¹, xₜ¹)(dₜ², xₜ²) . . . (dₜ^{N}, xₜ^{N}), as the vector of random variable, Gaussian Process may assume that a finite set of output samples may jointly normally distributed with zero mean and covariance matrix Σ (assuming the dataset has been normalized):

$${d}_{t}^{1} , {d}_{t}^{2} , … {d}_{t}^{N} ∼ 𝒩 ( 0 , \sum ) . \qquad ( 8 )$$

The covariance matrix Σ in the GP prior as expressed by expression (8) may be determined from the data. For example, the matrix may be populated element-wise using a kernel function κ(·,·) such that

$$\sum ( X ) = {[ κ ( {x}_{t}^{k} , {x}_{t}^{q} ) ]}_{k , q ∈ [ 1 , … N ]} , \qquad ( 9 )$$

where (k, q) are row and column numbers, and X=[xₜ¹, xₜ², . . . xₜ^{N}] is used for simpler notation.

A deviation dₜ* may be predicted for a new query impacting factor Xₜ* that enters the dataset. The underlying assumption that outputs are jointly normally distributed may remain valid. According,

$${d}_{t}^{1} , {d}_{t}^{2} , … {d}_{t}^{N} , {d}_{t}^{*} ∼ 𝒩 ( {0}_{N + 1} , [ \begin{matrix}\sum & {\sum }_{N \times 1}^{*} \\ {\sum }_{N \times 1}^{* T} & κ ( x , {x}_{t}^{*} )\end{matrix} ] ) . \qquad ( 10 )$$

For convenience of notation, D=[dₜ¹, dₜ², . . . dₜ^{N}]^{T} and Σ*=Σ_{N×1}*. Conditional probability distribution p(dₜ*|D, X) may be expressed based on the joint probability distribution (10). Since a multivariate normal distribution is closed under conditioning operation,

$${d}_{t}^{*} \vert D , X ∼ 𝒩 ( {\sum }_{N \times 1}^{* T} \cdot {\sum }^{- 1} \cdot D , k ( {x}_{t}^{*} , {x}_{t}^{*} ) - {\sum }_{N \times 1}^{T} \cdot {\sum }^{- 1} \cdot {\sum }_{N \times 1} ) . \qquad ( 11 )$$

Equation (11) may provide an expected value and variance of future trajectory deviation output dₜ*. The expected value can be understood as the non-parametric, nonlinear correction of the dynamics model. The variance may provide high confidence bounds of trajectory deviation from an upstream request and as such serve as an estimate of the uncertainty.

The GP model can be described as a nonlinear interpolator that predicts outputs by correlating query impact factors with the input-output pairs from the online dataset which appears as D and X in equation (11). The accuracy of the online procedure may depend on the quality of information contained in D and X. From information theoretic perspective, the samples D and X may maximize the information content about infinite dimensional space of all possible (dₜ, xₜ). It may be beneficial that the dataset is diverse and evenly distributed over the high dimensional space of impactors. One or more measures may be taken to improve or optimize information content. For example, the inference time may grow quadratically with the size of the dataset (O(N²) when the inverse covariance matrix is pre-computed; otherwise, the time complexity may be O(N³)). For large datasets, the time complexity can cause problems in the context of downstream modules like planning and control that have rigorous hard real-time requirements and tight schedule. The modeling approach may strike a balance between the information quality and the size of the dataset.

A diverse dataset may need to cover a set of scenarios in which the control task needs to operate. Example scenarios may include light braking, hard braking, onramp accelerating, passing, cruising at constant speed, front vehicle cut-in, local road turning, etc. The impact of uncertainty factors on tracking performance may vary among each of these events. For instance, unforeseen road surface variation tends to adversely affect more on transient response like hard braking events than steady state cruising, adding more uncertainty. Given the varying occurrence of these events, additional efforts may be needed to ensure the online dataset is balanced across a wide range of scenarios.

Additionally or alternatively, sample data may need to be processed in terms of data volume, considering that an excessive amount of samples with high computational overhead may hinder or prohibit its use in online deployment of a GP model. To address this issue and reduce the size of an online dataset, an appropriate data amount may be determined by evaluating the correlation between the quality of the model predictions and the amount of data to be included, e.g., in a set of balanced data. Merely by way of example, the evaluation may start with a certain number (e.g., 30, 40, 50, 60, etc.) of pairs (dₜ, xₜ) selected (e.g., substantially uniformly) from a 2D grid of speed and acceleration errors. Then, points may be added sequentially, where each point is added in a way that optimizes mutual information of points selected so far and the newly added point. This process may strategically select and add data points from a 2D grid of speed and acceleration error to an online dataset, optimizing mutual information to ensure the inclusion of most informative points, thereby reducing information entropy and enhancing prediction accuracy. Additional description regarding data preparation may be found elsewhere in the present document. See, e.g., 710 of FIG. 7A and tuning loop 740 in FIG. 7E.

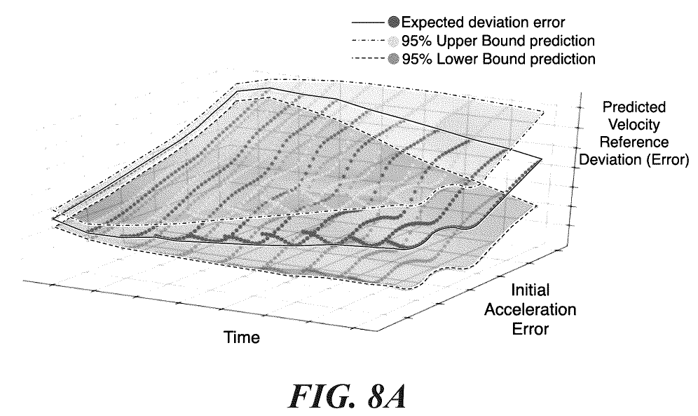

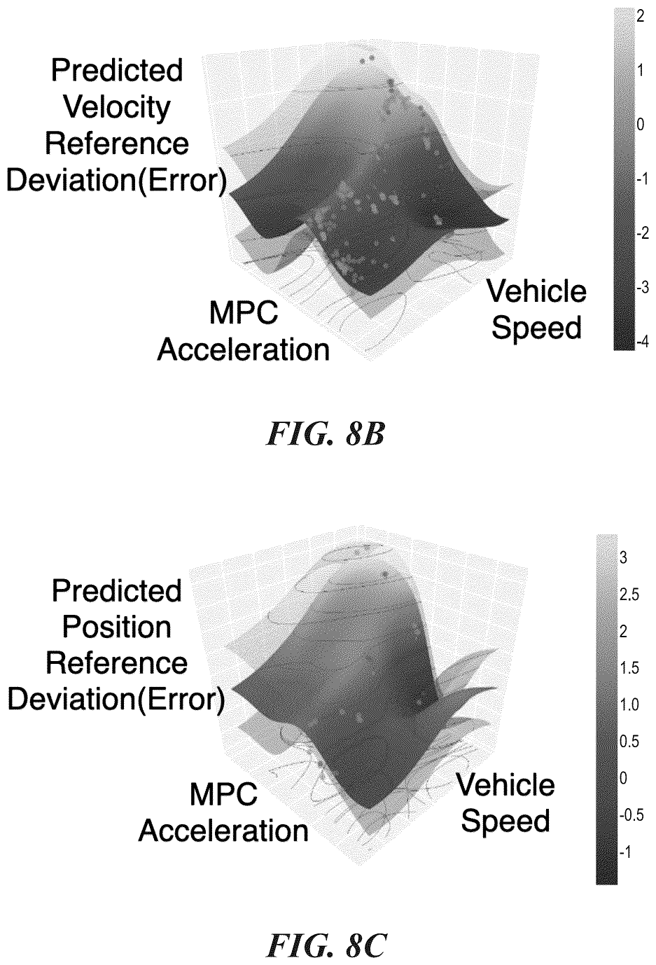

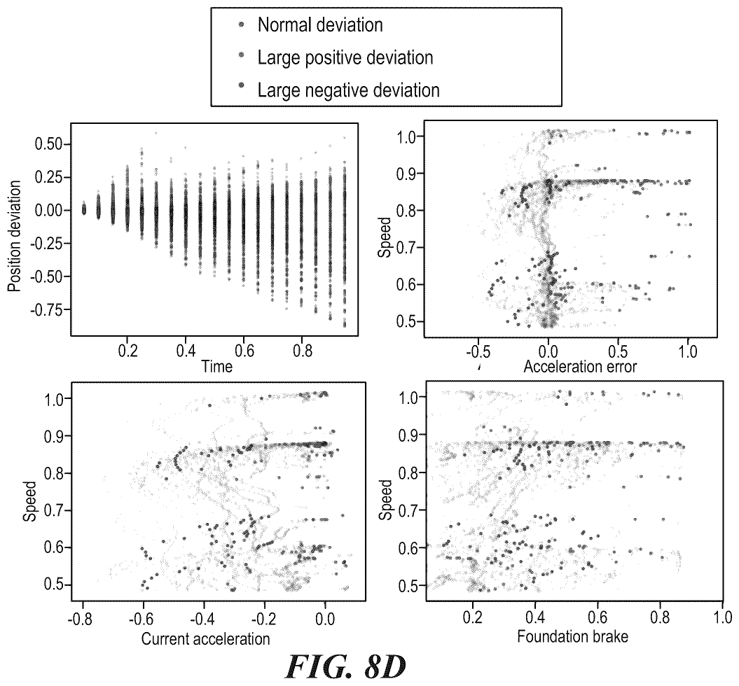

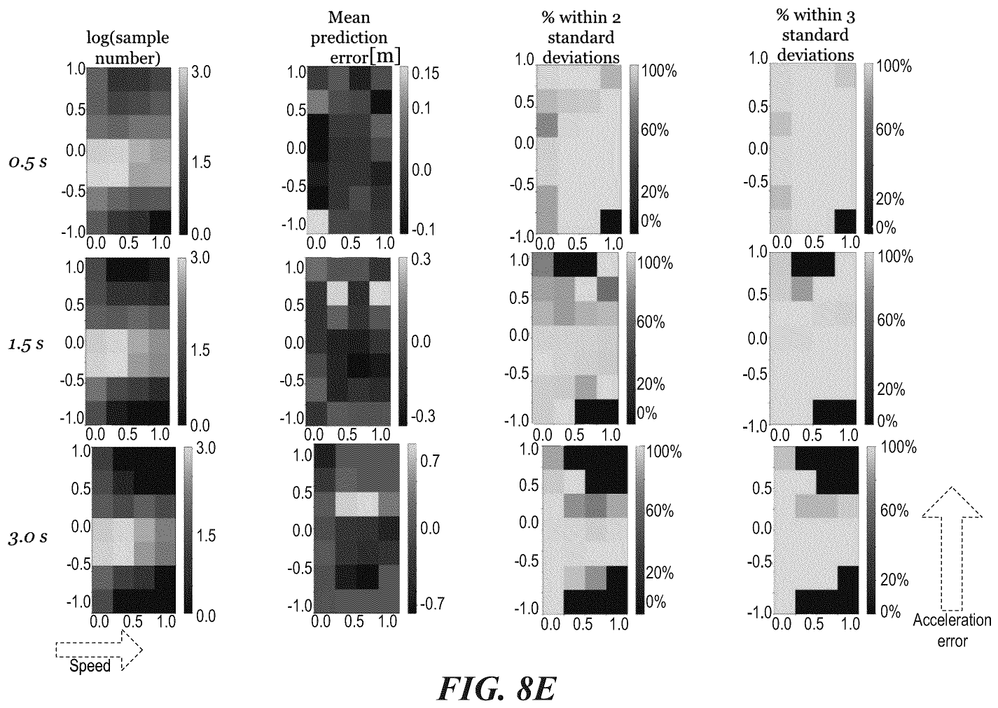

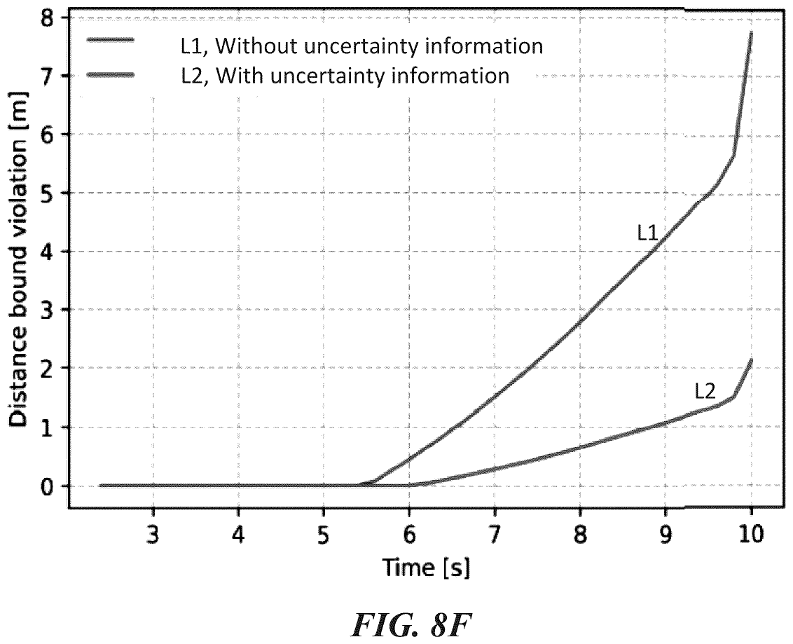

Dataset selected according to some embodiments of the present document may be used to train an uncertainty model. See, e.g., FIG. 7A and the description thereof. A trained model may need to be validated before its online deployment. The validation may be beneficial, considering the model may be applied in a safety critical context of autonomous driving. In some embodiments, a thorough and high-resolution model validation methodology may be performed. In some embodiments, a single global metric may be employed. In some embodiments, a model validation over a multi-dimensional metric may be used. For illustration purposes, a model validation over a 2D grid of speed and acceleration error pairs of interval-bins may be performed. See, e.g., FIG. 8E and description thereof. A multi-dimensional metric may contextualize model validation and provide an opportunity to spot local regions where the model performance is substandard.

In a model validation over a 2D grid of speed and acceleration error pairs, a bin from the grid may yield local validation metrics separately. Merely by way of illustration, the two validation metrics used may include an average mean prediction error and an average standard deviation prediction error. The ground truth for evaluating mean prediction may be immediately available as the deviation value dₜⁱ in the data pair (dₜⁱ, xₜⁱ) and the mean prediction error may be evaluated as follows:

$${e}_{mv}^{μ} = \frac{1}{N} \sum ( \vert {μ}_{G P} ( {x}_{t}^{i} ) - {d}_{t}^{i} \vert ) . \qquad ( 12 )$$

The ground truth for standard deviation σₑₛₜ(xₜⁱ) may be estimated from the population in the neighborhood Sᵢ of xₜⁱ using an estimator, e.g.,

$${σ}_{est} = \frac{1}{\vert {S}_{i} \vert - 1} {\sum }_{{d}_{t}^{i} ∈ {S}_{i}} {( {d}_{t}^{i} - {μ𝒮}_{i} )}^{2} . \qquad ( 13 )$$

The standard validation can be used as follows:

$${e}_{m v}^{σ} = \frac{1}{N} \sum ( \vert {σ}_{G P} ( {x}_{t}^{i} ) - {σ}_{est} ( {x}_{t}^{i} ) \vert ) . \qquad ( 14 )$$

The percentage of data samples from the bin that fall within, e.g., two and/or three predicted standard deviations around the mean may be measured. The validation metric may be selected by balancing the need to ensure safe model deployment with the need to avoid overly conservative predictions. For example, a standard deviation prediction that makes 95% of the samples fall within two standard deviations and 99.7% of samples within three standard deviations from the mean may be considered accurate. The example metric indicates that the trajectory tunnel of three predicted standard deviations may contain future trajectory with high 99.7% confidence to ensure safe model deployment, while the trajectory tunnel of two predicted standard deviations may contain no more than 95% of future trajectories on average to avoid being overly conservative in model prediction.

For impacting factors of different numerical scales, they can be normalized to zero mean and unit variance. xₜⁱ may represent normalized impacting factors.

The selection of kernel may be based on one or more considerations including, e.g., that the output trajectory is smooth, that the kernel may support noisy output observations, or the like or a combination thereof. An example of a suitable kernel is radial basis function (RBF) kernel with additive white noise σ_{w} term. Accordingly:

$$κ ( {x}_{t}^{k} , {x}_{t}^{q} ) = {e}^{- 0.5 * {‖ {x}_{t}^{k} - {x}_{t}^{q} ‖}_{W +}^{2}} \{ \begin{matrix}{σ}_{w}^{2} & if {x}_{t}^{k} = {x}_{t}^{q} \\ 0 & if {x}_{t}^{k} \neq {x}_{t}^{q}\end{matrix} , \qquad ( 15 )$$

where W is used to weigh significance of different impacting factors in estimating correlation between them.

Based on a dataset (e.g., a balanced dataset with respect to event types and/or data amount as described elsewhere in the present document), data pairs (D, X) may be generated. To use the model generated based on the data pairs online, the data pairs may need to be stored in memory. To accelerate the online inference, Σ_{N×N}⁻¹ equation (11) may be precomputed offline. The only operations that need to be performed online may include computing equation (16) below, and then computing the mean and variance in equation (11).

$${\sum }_{N \times 1}^{*} = {[ κ ( {x}_{t}^{k} , {x}_{t}^{*} ) ]}_{k ∈ [ 1 , … N ]} . \qquad ( 16 )$$

With this setup, both time and memory of runtime algorithm scale quadratically O(N²) with the number of data pairs, which may be sufficiently fast with the dataset of an appropriate size as discussed elsewhere in the present document.

Trajectory deviation mean and variance predicted using the uncertainty model can naturally inform a controller (e.g., an MPC controller) and make the controller reactive to varying levels of predicted uncertainty, thereby integrating risk management into MPC formulation. In some embodiments, an MPC may allow a user to specify constraints that a generated trajectory should fall within. Such constraints may relate to context information that describes or corresponds to a state of a vehicle, as described elsewhere in the present document. For example, the context information and/or the constraints may reflect mechanical capacities of the vehicle. These constraints may play a significant role in dense traffic scenarios with tight operating spaces. The output of a control task that employs MPC may still deviate from request and/or violate soft constraints in tight constraint environment like high density traffic. Integrating predicted deviation using GP methods as described into the soft constraint setting may help attenuate the situation. More description regarding the constraints, the context information, and their integration into MPC control may be found in, e.g., U.S. Provisional Application No. 63/502,571 filed May 16, 2023, and U.S. Patent Application No.______ (Attorney Docket No.: 128000.8259.US01), filed on even date, the contents of each of which are incorporated by reference.

The mean and standard deviation of trajectory deviation predicted using the uncertainty model as disclosed herein may be expressed as:

$$μ ( {d}_{t}^{*} ) = [ μ ( {d}_{1}^{*} ) , μ ( {d}_{2}^{*} ) , … μ ( {d}_{T}^{*} ) ] , \qquad ( 17 )$$

$$and σ ( {d}_{t}^{*} ) = [ σ ( {d}_{1}^{*} ) , σ ( {d}_{2}^{*} ) , … σ ( {d}_{T}^{*} ) ] , \qquad ( 18 )$$

where dᵢ* may be computed using GP models. Approximately 99% confidence lower and upper bounds of trajectory deviation can be expressed as:

$${d}_{LB / UB}^{*} = μ ( {d}_{t}^{*} ) - / + 3 \cdot σ ( {d}_{t}^{*} ) . \qquad ( 19 )$$

These bounds may be added to a requested state (e.g., position, speed) constraints from the mission planner (e.g., mission planning module 140 as illustrated in FIG. 1, mission planner 910 in FIG. 9), creating soft constraints for the MPC solver (or MPC controller). Accordingly, this design may integrate risk measure into a negative feedback loop and thereby intelligently manages the uncertainty present in a control task.

FIG. 7A shows a process 700 for generating an uncertainty model according to some embodiments of the present document. At 710, the process 700 may obtain sample driving event data relating to sample events, each of the sample events belonging to one of a plurality of driving scenarios. In some embodiments, the sample driving event data may be balanced. For example, the sample driving event data may include first training data sets of first sample events belonging to a first driving scenario and second training data sets of second sample events belong to a second driving scenario; the sample driving event data may be balanced such that a first sample event count (or the data amount) of the first sample events is comparable to (e.g., in a same order as) a second sample event count of the second sample events. Merely by way of example, the first sample event count (or the data amount) and the second sample event count may both be in the order of 10 (e.g., 50 and 50, respectively; 50 and 60, respectively), or 100 (e.g., 500 and 500, respectively; 500 and 560, respectively), or 1000 (e.g., 1100 and 1100, respectively; 1100 and 1200, respectively), etc.

In some embodiments, the sampling driving event data may be obtained according to the process including one or more of the following steps. The process 400 may retrieve candidate sample driving event data of candidate sample events, and identify at least a portion of the candidate sample events as belonging to one of the plurality of driving scenarios based on respective candidate sample driving event data of each of the candidate sample events; and compiling the sample driving event data based on a sample event count of candidate sample events in each of the plurality of driving scenarios such that the sample driving event data are balanced. In some embodiments, the plurality of driving scenarios may include at least one of light braking whose braking pressure is below a first brake pressure threshold, hard braking whose braking pressure is above a second brake pressure threshold, on-ramp acceleration, passing, cruising at a constant speed whose acceleration is below an acceleration threshold, front vehicle cut-in, or a turning whose angular velocity exceeds an angular velocity threshold.

In some embodiments, for each of the candidate sample events, candidate sample driving event data may be assigned to one of a plurality of driving scenarios based on the respective sample driving event data. For example, by comparing the sample driving event data of a candidate sample event with at least one of the first brake pressure threshold, the second brake pressure threshold, the acceleration threshold, or the angular velocity threshold, at least a portion of the candidate sample events may be identified as belonging to one of the plurality of driving scenarios based on a result of the comparison.

Training data including sample driving event data may be balanced such that information from various driving scenarios may be learned by the uncertainty model. As regular driving events (e.g., cruising) occur much more often than outlier events (e.g., hard brake on a highway), more candidate driving event data from such regular driving events may be available than outlier events. Accordingly, candidate sample driving event data may need to be selected to achieve balanced training data. In some embodiments, sample driving event data may be normalized before being used to train the uncertainty model. Merely by way of example, the contributing factors may be normalized using standard zero mean and unit variance statistical scaling algorithm. Additionally or alternatively, the input of the uncertainty model may also be subject to normalization before being applied to the uncertainty model. In some embodiments, the sample driving event data may include synthetic data generated by oversampling prior driving events based on an oversampling algorithm. Examples of the oversampling algorithm include random oversampling, synthetic minority oversampling technique (SMOTE), borderline-SMOTE, borderline oversampling with SVM, adaptive synthetic sampling (ADASYN), etc.

At 720, the process 700 may generate the uncertainty model by machine learning using the sample driving event data based on a multivariate probability prediction algorithm. In some embodiments, the uncertainty model so trained may be configured to predict uncertainty information that relates to a deviation of an operation of a vehicle according to an intended control instruction from an intended operation of the vehicle according to planning information, the intended control instruction being determined based on the planning information.

FIG. 7B shows a process for generating a Gaussian process based uncertainty model according to some embodiments of the present document. Bags of data (I) and the selective sampling (II) may correspond to candidate sample driving event data and the selection of sample driving event data from the candidate sample driving event data described at 710, the description of which is not repeated here. The selected driving event data may correspond to driving events belonging to one of a plurality of driving scenarios including hard braking, light braking, passing, cruising (e.g., cruising at a constant speed), local turns, and accelerating on a ramp and grouped accordingly as indicated by III. A Gaussian Process (GP) based model may be trained using the sample driving event data by model fitting (IV). The obtained model may be validated or tested at model validation (V). If the obtained model passes the validation (VI), the model may be returned to II for further training using fresh sample driving event data and/or sample driving event data already used in prior training step. Due to the probabilistic nature of the model, a same set of sample driving event data may be processed to generate a different outlet. A same set of sample driving event data may be re-used for training If the obtained model passes the validation (V), the model may proceed to model tuning (VI) from which a GP model may be determined (VII). In some embodiments, the model tuning may include a process of selecting or adjusting hyperparameters in the uncertainty model determined by model fitting illustrated in panel IV. Different choices of hyperparameters may result in different validation results. The validation and tuning operations illustrated in panel V and panel VI may be performed iteratively (as indicated by the arrow from panel VI to panel V until the validation converges to a steady state value.

FIG. 7C shows an example configuration of an uncertainty model according to some embodiments of the present document. As illustrated, the uncertainty model is constructed based on a Gaussian process. The input to the model may include context information to I (“ComputeFeatures”) and a specified confidence level (illustrated as confidence level request in FIG. 7C) to VI (“Inverse error function”). The features (e.g., values of the operation parameters embedded in the context information may be extracted at I. The uncertainty model may include a Gaussian process regressor II or a basic Gaussian predictor III. The uncertainty model may be stored in a Json file in an in-vehicle control module (e.g., vehicle control 150 as illustrated in FIG. 1, longitudinal MPC 930 as illustrated in FIG. 9, In-Vehicle Control Computer 1050 as illustrated in FIG. 10). The uncertainty model may be employed to predict uncertainty information online as illustrated in, e.g., FIGS. 4-6 and relevant description thereof. The output of the uncertainty model may include a confidence range expressed as a mean deviation with a standard deviation. For example, a dynamic MPC controller may be configured to complete the determination of the uncertainty information and the generation of the control instruction with respect to the prediction horizon within less than 1 second, e.g.,0.8 seconds, 0.5 seconds, 0.4seconds, 0.2 seconds.

FIG. 7D shows a flow of an example application of an uncertainty model according to some embodiments of the present document. Level I shows example information to be used as the context at level II. Example information may include a requested confidence level, a reference trajectory (e.g., an intended trajectory determined based on planning information), and one or more context topics. Example context topics include vehicle speed (also referred to as velocity), road grade, road curvature, etc. The context information may be input to the uncertainty model (referred to as a trajectory predictor in FIG. 7D) at level III. Model arbitrator III-1 may determine into which component predictors III-21, III-22, and III-23, the context information is to be sent. Each of the component predictors III-21, III-22, and III-23 may output a deviation component regarding an operation parameter (e.g., speed, position, acceleration). In some embodiments, instead of multiple component predictors (or referred to as component uncertainty predictors), a single model may be configured to output multiple deviation components. In some embodiments, instead of predicting the entire output (tile entire row IV including predictions IV-21, IV-22, and IV 23, and interpolates IV-31, IV-32, and IV-33) for the prediction horizon directly, the uncertainty model may predict only several points directly (e.g., IV-21, 22, 23) and the remaining output points (IV-31, 32, 33) may be computed by interpolating several predicted points. The predicted results IV-21, IV-22, and IV-23 may from the component predictors III-21, III-22, and III-23 may be input to each of interpolators III-31, III-32, and III-33 to be interpolated. As illustrated, predicted results IV-21 and IV-22 may be input to interpolator III-31 to provide IV-31; predicted results IV-22 and IV-23 may be input to interpolator III-32 to provide IV-32; predicted results IV-22 and IV-23 may be input to interpolator III-33 to provide IV-33.

FIG. 7E illustrates uncertainty model training and application pipelines according to some embodiments of the present document. Panel A shows the offline model training Panel B shows the online model application. The offline model training in panel I is similar to what is shown in FIG. 7B. Bags of data (I) and the event extraction (II′) may correspond to candidate sample driving event data and the selection of sample driving event data from the candidate sample driving event data described at 710. Through the event extraction (II′), one or more processors configured to perform data collection and/or processing for the model training may identify and/or label a dataset based on a driving scenario represented therein. Examples of driving scenarios may include braking (hard braking, light braking), free cruising, following traffic, passing, executing cut-in, merging, lane changing, accelerating on ramps, decelerating on off-ramps, local turns, etc. Selected bags of data may be grouped based on their respective driving scenarios as indicated in III. The event data can then be adjusted by balanced sampling so that the sample event counts (or the data amounts) of sample events are comparable, e.g., in a same order. The amount of data in the dataset (III) may be determined based on, e.g., a tuning loop as described elsewhere in the present document. The one or more processors may use the dataset (III) to train a hyperparameter optimizer (IV′) to be used as an uncertainty model. The one or more processors may validate the model by performing model validation (V) to test whether the trained model is suitable to be used as the GP model (VII) for online deployment. If the one or more processors determine that more model training is needed, the one or more processors may send the current model to further training/tuning (VI) based on the current dataset. This approach may be suitable if the one or more processors determine that the current dataset (X) has enough data and/or if more data would negatively impact the online application of the dataset with a trained GP model (VII)). Alternatively, the one or more processors may also return to 730 to retrieve additional data to generate an updated dataset (X) for further model training This approach may be suitable if the one or more processors determine that the current dataset (X) is insufficient and/or if more data may improve the model training without hindering the online application of the dataset (X) with a trained GP model (VII) to an unacceptable extent). If the one or more processors determine that the model training is sufficient, the one or more processors may provide the GP model (VII) to online deployment as indicated in panel B. The one or more processors may determine that the dataset (X), with a size N, may be suitable for sufficient model training to provide the GP model (VII) and also for online deployment with the trained GP model (VII) as indicated in panel B.

In the online deployment as illustrated in panel B, one or more processors (e.g., vehicle control 150 as illustrated in FIG. 1, longitudinal MPC 930 as illustrated in FIG. 9, In-Vehicle Control Computer 1050 as illustrated in FIG. 10) may use the GP model (VII) and the dataset (X) determined offline as indicated in panel A to predict deviations (or referred to as uncertainty information) from reference information (e.g., requested trajectory of a state of the vehicle) at deviation predictor VIII. The one or more processors may use the predicted deviations or uncertainty information to determine constraints and cost functions in determine an improved or optimal control input at the MPC controller (IX). The deviation predictor VIII and/or the MPC controller (IX) may also use context information with the requested trajectory in predicting the uncertainty information and/or determining the control input. The control input may be used to control the operation of the vehicle.

The performance of a GP model may be evaluated in the context of a braking event, a propulsion event, or the like, or a combination thereof. Merely by way of example, a model validation in the context of a braking event (e.g., a hard braking event) may be beneficial for at least the following reasons. A standard vehicle dynamics models may be inaccurate during hard braking event due to, e.g., tire nonlinearity at high slip ratio region and the brake system entering domain with large lag dynamics. In addition, hard braking events may be under-represented in the dataset due to their rare occurrence, compared to other scenarios such as following, light braking events, etc. GP models may handle these contexts well since they provide high uncertainty output in the state-space regions that lack sufficient data.

FIG. 8A shows results of an example uncertainty model with respect to braking events according to some embodiments of the present document. The uncertainty model may be GP based. The time axis and the axis showing the initial acceleration error are in the horizontal plane, while the vertical axis shows the predicted velocity error (also referred to as predicted velocity reference deviation. The top surface (marked with a dash-dotted outline) and the bottom surface (marked with a dashed outline) show the upper bound and the lower bound of the velocity with a 95% confidence level predicted by the example braking uncertainty model, while the dots in the surface (marked with a solid outline) between the top surface and the bottom surface show the expected errors (e.g., the mean deviation as the uncertainty model predicts) in velocity.

FIGS. 8B and 8C show predicted velocity and position reference deviations (or referred to as error) into the future (2 seconds as illustrated) during propulsion, respectively. The uncertainty model may be GP based. In FIG. 8B, the solid surface (between the transparent surfaces) illustrates the expected velocity deviations predicted by the uncertainty model. Transparent surfaces are 98% confidence range of the predicted results. The total number of data points is approximately 700. As illustrated in FIG. 8B, the example propulsion may be characterized mostly by underdelivery at low-mid speed and slight overdelivery in scenarios when the speed had to be maintained constant. The color bar in FIG. 8B shows the correspondence between the color (greyscale) and the value from −4 (at the bottom of the color bar) and 2 (at the top of the color bar).

In FIG. 8C, the transparent surfaces are 98% confidence range of prediction. The solid surface (between the transparent surfaces) illustrates the results predicted by the uncertainty model. The total number of data points is approximately 12,000. As illustrated in FIG. 8C, the example braking may be characterized mostly by overdelivery at all speed levels. Significant overdelivery may be expected during sudden harsh braking scenarios at a highway speed, as illustrated in FIG. 8C. The color bar in FIG. 8C shows the correspondence between the color (greyscale) and the value from −1 (at the bottom of the color bar) and 3 (at the top of the color bar).

FIG. 8D shows results predicted by an uncertainty model with respect to hard braking events according to some embodiments of the present document. As used herein, a hard braking event may refer to an instance where an autonomous vehicle applies its brakes at a force significantly above its typical operational range to rapidly reduce speed. This action may be triggered by, e.g., an imminent need to avoid a collision, respond to a sudden traffic change, or adapt to a rapid alteration in a road condition. The event is characterized by a deceleration rate that exceeds a predefined threshold. A hard brake event may have two main phases. In the first phase, a vehicle may use most of its braking capacity to decelerate aggressively, but due to system delay, the vehicle may lead (decelerates less than) requested trajectory. In the second phase, due to saturations and momentum in the braking system, the vehicle may lag (over-decelerate) noticeably. In panels (b), (c), and (d) of FIG. 8D illustrate three core impacting factors, acceleration error, current acceleration, and foundation brake pressure against speed which is also an impacting factor in hard braking events. The results in FIG. 8D visually illustrate that the four impacting factors may carry predictive power in hard braking events.

FIG. 8E illustrates the validation results of an uncertainty model for 3 future time stamps (0.5 s, 1.5 s, 3.0 s) according to some embodiments of the present description. The uncertainty model may be GP based. The results are with respect to hard braking events. On each subplot, y-axis displays normalized acceleration error and x-axis displays normalized speed. The 2D space is discretized into a grid of bins, each bin corresponding to an interval of speed and acceleration error. Units are omitted because the values are normalized. The leftmost column shows the logarithm of the total number of samples in each bin. The second column shows the average mean prediction error for each bin. The last two columns show the percentage of validation samples from the bin that fall within 2 and 3 predicted standard deviations from the predicted mean, respectively. The legend for each plot is a grayscale value going from black (lowest value) to white (highest values). The positive and negative acceleration error indicates lead and lag, respectively. Although the validation is visualized over two impacting factors only, the uncertainty model is using a full set of impacting factors to build a covariance matrix during prediction.

As illustrated, the bins with large amounts of data (e.g., first column on FIG. 3) have high accuracy mean prediction. While some of the bins with a lower number of validation samples have higher mean prediction error, the predicted standard deviation is typically also higher, so that final 3 standard deviation tunnel contains most of the trajectory validation points with high confidence. There are bins with no data samples in which case 3 metrics columns are meaningless. Such a high resolution validation may serve as a tool to judge the readiness of an uncertainty model trained offline for online deployment.

Additional global results from the example validation in FIG. 8E include that the average mean prediction error over the entire validation dataset measures μ_{G}≈−0.086m with σ_{G}≈0.091m standard deviation. Although there are bins in FIG. 8E. that appear to suggest higher mean and deviation in prediction error, it turns out that low accuracy bins have too few examples to noticeably influence the global result. The GP performance in the bins with high amounts of samples may indicate that had these bins carry more samples, the prediction error would be lower.

The model validation presented may suggest high confidence in the model performance and thereby may qualify it for online deployment. The uncertainty model may provide information for properly compensating uncertainty in vehicle operation to improve safety. For example, for hard braking events, the uncertainty model may provide information for properly compensating deceleration uncertainty which is safety critical. Knowing the limits of braking system beforehand can lead to a well informed decisions, e.g., to change the lane, instead of braking hard, thereby reducing the collision risk.

FIG. 8F illustrates results of an online model validation according to some embodiments of the present document. L1 shows violation of a distance bound based on a baseline control framework without considering uncertainty information. L2 shows violation of a distance bound based on a constraint-defined control framework that takes into consideration of uncertainty information predicted by an uncertainty model according to some embodiments of the present disclosure. More information regarding the two control frameworks may be found at, e.g., U.S. Provisional Application No. 63/502,571 filed May 16, 2023, and U.S. Patent Application No.______ (Attorney Docket No.: 128000.8259.US01), filed on even date, the contents of each of which are incorporated by reference. The results illustrate that uncertainty informed constraints make the generated trajectory violate expected constraints later and in lesser amount. The results suggest that the uncertainty model (or referred to as an uncertainty predictor) may inform constraints design to generate a risk-averse trajectory.

FIG. 9 shows an example of a hardware platform 900 that can be used to implement some of the techniques described in the present document. For example, the hardware platform 900 may implement process 700 or may implement the various modules described herein. The hardware platform 900 may include a processor 902 that can execute code to implement a method. The hardware platform 900 may include a memory 904 that may be used to store processor-executable code and/or store data. The hardware platform 900 may further include a control interface 906. For example, the control interface 906 may implement one or more intra-vehicular communication protocols. The hardware platform may further include a mission planner 910, a control decoupler 920 and a longitudinal MPC 930. In some embodiments, some portion or all of the mission planner 910, the control decoupler 920 and/or the longitudinal MPC 930 may be implemented in the processor 902. In other embodiments, the memory 904 may comprise multiple memories, some of which are exclusively used by the mission planner, control decoupler and/or longitudinal MPC.

FIG. 10 illustrates a block diagram of an example vehicle ecosystem according to some embodiments of the present document. Embodiments of systems and methods of the present document may be implemented on system 1000 as illustrated. The system 1000 may include an autonomous vehicle 1005, such as a tractor unit of a semi-trailer truck. The autonomous vehicle 1005 may include a plurality of vehicle subsystems 1040 and an in-vehicle control computer 1050. The plurality of vehicle subsystems 1040 can include, for example, vehicle drive subsystems 1042, vehicle sensor subsystems 1044, and vehicle control subsystems 1046. FIG. 10 shows several devices or systems being associated with the autonomous vehicle 1005. In some embodiments, additional devices or systems may be added to the autonomous vehicle 1005, and in some embodiments, some of the devices or systems shown in FIG. 10 may be removed from the autonomous vehicle 1005.

An engine/motor, wheels and tires, a transmission, an electrical subsystem, and/or a power subsystem may be included in the vehicle drive subsystems 1042. The engine/motor of the autonomous truck may be an internal combustion engine (or gas-powered engine), a fuel-cell powered electric engine, a battery powered electric engine/motor, a hybrid engine, or another type of engine capable of actuating the wheels on which the autonomous vehicle 1005 (also referred to as vehicle 1005 or truck 1005) moves. The engine/motor of the autonomous vehicle 1005 can have multiple engines to drive its wheels. For example, the vehicle drive subsystems 1042 can include two or more electrically driven motors.

The transmission of the vehicle 1005 may include a continuous variable transmission or a set number of gears that translate power created by the engine of the vehicle 1005 into a force that drives the wheels of the vehicle 1005. The vehicle drive subsystems 1042 may include an electrical system that monitors and controls the distribution of electrical current to components within the vehicle drive subsystems 1042 (and/or within the vehicle subsystems 1040), including pumps, fans, actuators, in-vehicle control computer 1050 and/or sensors (e.g., cameras, LiDARs, RADARs, etc.). The power subsystem of the vehicle drive subsystems 1042 may include components which regulate a power source of the vehicle 1005.

Vehicle sensor subsystems 1044 can include sensors which are used to support general operation of the autonomous truck 1005. The sensors for general operation of the autonomous vehicle may include, for example, one or more cameras, a temperature sensor, an inertial sensor, a global positioning system (GPS) receiver, a light sensor, a light detection and ranging (LiDAR) system, a radio detection and ranging (RADAR) system, and/or a wireless communications system.

The vehicle control subsystems 1046 may include various elements, devices, or systems including, e.g., a throttle, a brake unit, a navigation unit, a steering system, and an autonomous control unit. The vehicle control subsystems 1046 may be configured to control operation of the autonomous vehicle, or truck, 1005 as a whole and operation of its various components. The throttle may be coupled to an accelerator pedal so that a position of the accelerator pedal can correspond to an amount of fuel or air that can enter the internal combustion engine. The accelerator pedal may include a position sensor that can sense a position of the accelerator pedal. The position sensor can output position values that indicate the positions of the accelerator pedal (e.g., indicating the amount by which the accelerator pedal is actuated.)

The brake unit can include any combination of mechanisms configured to decelerate the autonomous vehicle 1005. The brake unit can use friction to slow the wheels of the vehicle in a standard manner. The brake unit may include an anti-lock brake system (ABS) that can prevent the brakes from locking up when the brakes are applied. The navigation unit may be any system configured to determine a driving path or route for the autonomous vehicle 1005. The navigation unit may additionally be configured to update the driving path dynamically based on, e.g., traffic or road conditions, while, e.g., the autonomous vehicle 1005 is in operation. In some embodiments, the navigation unit may be configured to incorporate data from a GPS device and one or more predetermined maps so as to determine the driving path for the autonomous vehicle 1005. The steering system may represent any combination of mechanisms that may be operable to adjust the heading of the autonomous vehicle 1005 in an autonomous mode or in a driver-controlled mode of the vehicle operation.

The autonomous control unit may include a control system (e.g., a computer or controller comprising a processor) configured to identify, evaluate, and avoid or otherwise negotiate potential obstacles in the environment of the autonomous vehicle 1005. In general, the autonomous control unit may be configured to control the autonomous vehicle 1005 for operation without a driver or to provide driver assistance in controlling the autonomous vehicle 1005. In some example embodiments, the autonomous control unit may be configured to incorporate data from the GPS device, the radar, the LiDAR, the cameras, and/or other vehicle sensors and subsystems to determine the driving path or trajectory for the autonomous vehicle 1005.

An in-vehicle control computer 1050, which may be referred to as a vehicle control unit or VCU, can include, for example, any one or more of: a vehicle subsystem interface 1060, a map data sharing module 1065, a driving operation module 1068, one or more processors 1070, and/or memory 1075. This in-vehicle control computer 1050 may control many, if not all, of the operations of the autonomous truck 1005 in response to information from the various vehicle subsystems 1040. The memory 1075 may contain processing instructions (e.g., program logic) executable by the processor(s) 1070 to perform various methods and/or functions of the autonomous vehicle 1005, including those described in this patent document. For instance, the data processor 1070 executes the operations associated with vehicle subsystem interface 1060, map data sharing module 1065, and/or driving operation module 1068. The in-vehicle control computer 1050 can control one or more elements, devices, or systems in the vehicle drive subsystems 1042, vehicle sensor subsystems 1044, and/or vehicle control subsystems 1046. For example, the driving operation module 1068 in the in-vehicle control computer 1050 may operate the autonomous vehicle 1005 in an autonomous mode in which the driving operation module 1068 can send instructions to various elements or devices or systems in the autonomous vehicle 1005 to enable the autonomous vehicle to drive along a determined trajectory. For example, the driving operation module 1068 can send instructions to the steering system to steer the autonomous vehicle 1005 along a trajectory, and/or the driving operation module 1068 can send instructions to apply an amount of brake force to the brakes to slow down or stop the autonomous vehicle 1005.

The map data sharing module 1065 can be also configured to communicate and/or interact via a vehicle subsystem interface 1060 with the systems of the autonomous vehicle. The map data sharing module 1065 can, for example, send and/or receive data related to the trajectory of the autonomous vehicle 1005 as further explained in Section II. The vehicle subsystem interface 1060 may include a software interface (e.g., application programming interface (API)) through which the map data sharing module 1065 and/or the driving operation module 1068 can send or receive information to one or more devices in the autonomous vehicle 1005.

The memory 1075 may include instructions to transmit data to, receive data from, interact with, or control one or more of the vehicle drive subsystems 1042, vehicle sensor subsystems 1044, or vehicle control subsystems 1046. The in-vehicle control computer (VCU) 1050 may control the operation of the autonomous vehicle 1005 based on inputs received by the VCU from various vehicle subsystems (e.g., the vehicle drive subsystems 1042, the vehicle sensor subsystems 1044, and the vehicle control subsystems 1046). The VCU 1050 may, for example, send information (e.g., commands, instructions or data) to the vehicle control subsystems 1046 to direct or control functions, operations or behavior of the autonomous vehicle 1005 including, e.g., its trajectory, velocity, steering, braking, and signaling behaviors. The vehicle control subsystems 1046 may receive a course of action to be taken from one or more modules of the VCU 1050 and may, in turn, relay instructions to other subsystems to execute the course of action.

The uncertainty prediction in the context of autonomous driving as disclosed herein may various technical benefits. For example, the method may predict a vehicle output trajectory deviation from reference (mission waypoints generated by a mission planner) in context of potentially unknown impacting factors. The method can model a large number of impacting factors holistically, instead of individually modeling each impactor using deterministic techniques, which is prohibitively expensive and complex undertaking.

As another example, an offline dataset generation and sampling framework as disclosed herein may result in information-rich dataset, balanced over high variety of scenarios. This may address the issue that in planning and control applications most raw dataset is steady-state cruising and transient events are underrepresented. Balancing the training data, as achieved through the offline dataset generation and sampling framework as disclosed herein, is beneficial because it may ensure that the uncertainty model is exposed to a diverse array of scenarios during training. By ensuring that transient events, which are typically underrepresented, are included in the training set, the uncertainty model can better generalize to real-world situations that are less common but can be critical to navigate safely. A balanced dataset thus helps in reducing bias and improving the robustness of the predictive model against a wide variety of driving conditions.

In addition, generating the model offline offers significant advantages, in reducing the computational load during live, online applications. In the context of autonomous driving, where processing resources and time are constrained, having the uncertainty model developed offline means that the online system needs to handle less data processing. This not only speeds up the online decision-making process but also conserves computational resources, which are crucial for real-time operations in autonomous vehicles. The offline model generation may allow for complex computations and the handling of large datasets without impacting the performance of the vehicle's operational systems.

The integration of balanced training data and offline model generation may contribute to a more efficient, reliable, and effective predictive model for autonomous driving. This approach may help address the challenges of managing extensive computations and ensure that the uncertainty model, and the planning and control modules incorporating uncertainty information predicted using the uncertainty model, is well-equipped to handle diverse and unpredictable driving scenarios, ultimately enhancing the safety and performance of autonomous vehicles. The uncertainty model as disclosed herein has been validated on statistically significant amounts of road testing data with coverage of major steady and transient scenarios. This shows that GP architecture can support high modality of scenarios in the dataset.

Some example technical solutions are implemented as described below.

1. A method for operating a vehicle, comprising: obtaining planning information relating to an intended operation of the vehicle over a prediction horizon; inputting the planning information into an uncertainty model to determine uncertainty information, wherein: the uncertainty model is trained using sample driving event data based on a multivariate probability prediction algorithm; and the uncertainty model is configured to predict the uncertainty information that relates to a deviation of an operation of the vehicle according to an intended control instruction from the intended operation, the intended control instruction being determined based on the planning information; generating a control instruction based on the planning information and the uncertainty information; and operating the vehicle based on the control instruction.

2. The method of any one or more of the solutions herein, wherein: the planning information and the intended operation relate to a plurality of operation parameters of the vehicle, and the uncertainty information comprises multiple deviation components each of which relates to one of the plurality of operation parameters.

3. The method of any one or more of the solutions herein, wherein the plurality of operation parameters comprise at least one of velocity, position, or acceleration of the vehicle.

4. The method of any one or more of the solutions herein, wherein the uncertainty model comprises a plurality of component uncertainty predictors each of which is configured to predict a deviation component of the uncertainty information for one of the plurality of operation parameters.

5. The method of any one or more of the solutions herein, further comprising inputting a target confidence level into the uncertainty model to determine the uncertainty information, wherein the target confidence level indicates a probability that the deviation of the operation of the vehicle from the intended operation falls within the uncertainty information.

6. The method of any one or more of the solutions herein, further comprising inputting context information into the uncertainty model to determine the uncertainty information, wherein the context information comprises at least one of a prior operation of the vehicle at a time point that precedes the prediction horizon, environmental information of an environment where the intended operation is to occur, or a known condition of the vehicle.

7. The method of any one or more of the solutions herein, wherein the uncertainty information relates to at least one of a mechanical capacity of the vehicle, an irregularity in the vehicle or a portion thereof, a difference between the intended operation and a prior operation of the vehicle at a time point that precedes the prediction horizon, a magnitude or rate of change of the operation during the intended operation or a portion thereof, an environment where the intended operation is to occur, or an irregularity of the planning information.

8. The method of any one or more of the solutions herein, wherein: the sample driving event data relates to sample events, each of the sample events belonging to one of a plurality of driving scenarios, and the plurality of driving scenarios comprise at least one of light braking whose braking pressure is below a first brake pressure threshold, hard braking whose braking pressure is above a second brake pressure threshold, on-ramp acceleration, passing, cruising at a constant speed, front vehicle cut-in, or a turning whose angular velocity exceeds an angular velocity threshold.

9. A method for training an uncertainty model, the method comprising: obtaining sample driving event data relating to sample events, each of the sample events belonging to one of a plurality of driving scenarios; and generating the uncertainty model by machine learning using the sample driving event data based on a multivariate probability prediction algorithm, wherein the uncertainty model is configured to predict uncertainty information that relates to a deviation of an operation of a vehicle according to an intended control instruction from an intended operation of the vehicle according to planning information, the intended control instruction being determined based on the planning information.

10. The method of any one or more of the solutions herein, wherein: the sample driving event data comprises first training data sets of first sample events belonging to a first driving scenario and second training data sets of second sample events belong to a second driving scenario, and the sample driving event data are balanced such that a first sample event count of the first sample events is in a same order as a second sample event count of the second sample events.

11. The method of any one or more of the solutions herein, wherein obtaining the sample driving event data comprises: retrieving candidate sample driving event data of candidate sample events; identifying at least a portion of the candidate sample events as belonging to one of the plurality of driving scenarios based on respective candidate sample driving event data of each of the candidate sample events; and compiling the sample driving event data based on a sample event count of candidate sample events in each of the plurality of driving scenarios such that the sample driving event data are balanced.

12. The method of any one or more of the solutions herein, wherein the plurality of driving scenarios comprise at least one of light braking whose braking pressure is below a first brake pressure threshold, hard braking whose braking pressure is above a second brake pressure threshold, on-ramp acceleration, passing, cruising at a constant speed whose acceleration is below an acceleration threshold, front vehicle cut-in, or a turning whose angular velocity exceeds an angular velocity threshold.

13. The method of any one or more of the solutions herein, wherein identifying at least a portion of the candidate sample events as belonging to one of the plurality of driving scenarios comprises: for each of the candidate sample events, comparing candidate sample driving event data with at least one of the first brake pressure threshold, the second brake pressure threshold, the acceleration threshold, or the angular velocity threshold; and

identifying the at least a portion of the candidate sample events as belonging to one of the plurality of driving scenarios based on a result of the comparison.

14. A system for operating a vehicle, comprising: a mission planner configured to provide planning information of the vehicle over a prediction horizon; a model predictive control (MPC) controller coupled to the mission planner and configured to perform steps including: obtaining, from the mission planner, the planning information relating to an intended operation of the vehicle over the prediction horizon; inputting the planning information into an uncertainty model to determine uncertainty information, wherein: the uncertainty model is trained using sample driving event data based on a multivariate probability prediction algorithm; and the uncertainty model is configured to predict the uncertainty information that relates to a deviation of an operation of the vehicle according to an intended control instruction from the intended operation, the intended control instruction being determined based on the planning information; and generating a control instruction based on the planning information and the uncertainty information; and a vehicle control interface coupled to the MPC controller to obtain the control instruction and configured to cause the vehicle to operate based on the control instruction.

15. The system of any one or more of the solutions herein, wherein the prediction horizon is at least 2 seconds, e.g., 3 seconds, 5 seconds, 6 seconds, 8 seconds, 10 seconds, or longer than 10 seconds.

16. The system of any one or more of the solutions herein, wherein the dynamic MPC controller is configured to complete the determination of the uncertainty information and the generation of the control instruction with respect to the prediction horizon within less than 1 second, e.g.,0.8 seconds, 0.5 seconds, 0.4 seconds, 0.2 seconds.

17. The system of any one or more of the solutions herein, further comprising a perception module configured to acquire environmental information of an environment, wherein the mission planner is configured to generate the planning information based on the environmental information.

18. The system of any one or more of the solutions herein, wherein the dynamic MPC controller is further configured to input the environmental information into the uncertainty model to determine the uncertainty information.

19. The system of any one or more of the solutions herein, wherein: the sample driving event data relate to sample events, each of the sample events belonging to one of a plurality of driving scenarios, and the sample driving event data are balanced such that sample event counts of sample events that belong to the plurality of driving scenarios, respectively, are in a same order.

20. The system of any one or more of the solutions herein, wherein: the MPC controller is further configured to input context information into the uncertainty model to determine the uncertainty information, the context information relates to a state of the vehicle during the operation of the vehicle.

21. The system of any one or more of the solutions herein, wherein: the planning information and the intended operation relate to a plurality of operation parameters of the vehicle; and the uncertainty model comprises a plurality of component uncertainty predictors each of which is configured to predict a deviation component of the uncertainty information for one of the plurality of operation parameters.

22. The system of any one or more of the solutions herein, further comprising a model training module configured to generate the uncertainty model.

23. An apparatus for controlling a vehicle, comprising a processor configured to perform steps including: obtaining planning information relating to an intended operation of the vehicle over a prediction horizon; inputting the planning information into an uncertainty model to determine uncertainty information, wherein: the uncertainty model is trained using sample driving event data based on a multivariate probability prediction algorithm; and the uncertainty model is configured to predict the uncertainty information that relates to a deviation of an operation of the vehicle according to an intended control instruction from the intended operation, the intended control instruction being determined based on the planning information; generating a control instruction based on the planning information and the uncertainty information; and operating the vehicle based on the control instruction.

24. One or more non-transitory computer readable program storage media having code stored thereon, the code, when executed by at least one processor, causing the at least one processor to implement one or more solutions herein.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for operating a vehicle, comprising:
obtaining planning information relating to an intended operation of the vehicle over a prediction horizon;
inputting the planning information into an uncertainty model to determine uncertainty information, wherein:
the uncertainty model is trained using sample driving event data based on a multivariate probability prediction algorithm; and
the uncertainty model is configured to predict the uncertainty information that relates to a deviation of an operation of the vehicle according to an intended control instruction from the intended operation, the intended control instruction being determined based on the planning information;
generating a control instruction based on the planning information and the uncertainty information; and
operating the vehicle based on the control instruction.

2. The method of claim 1, wherein:
the planning information and the intended operation relate to a plurality of operation parameters of the vehicle, and
the uncertainty information comprises multiple deviation components each of which relates to one of the plurality of operation parameters.

3. The method of claim 2, wherein the plurality of operation parameters comprise at least one of velocity, position, or acceleration of the vehicle.

4. The method of claim 2, wherein the uncertainty model comprises a plurality of component uncertainty predictors each of which is configured to predict a deviation component of the uncertainty information for one of the plurality of operation parameters.

5. The method of claim 1, further comprising inputting a target confidence level into the uncertainty model to determine the uncertainty information, wherein the target confidence level indicates a probability that the deviation of the operation of the vehicle from the intended operation falls within the uncertainty information.

6. The method of claim 1, further comprising inputting context information into the uncertainty model to determine the uncertainty information, wherein the context information comprises at least one of a prior operation of the vehicle at a time point that precedes the prediction horizon, environmental information of an environment where the intended operation is to occur, or a known condition of the vehicle.

7. The method of claim 1, wherein the uncertainty information relates to at least one of a mechanical capacity of the vehicle, an irregularity in the vehicle or a portion thereof, a difference between the intended operation and a prior operation of the vehicle at a time point that precedes the prediction horizon, a magnitude or rate of change of the operation during the intended operation or a portion thereof, an environment where the intended operation is to occur, or an irregularity of the planning information.

8. The method of claim 1, wherein:
the sample driving event data relates to sample events, each of the sample events belonging to one of a plurality of driving scenarios, and
the plurality of driving scenarios comprise at least one of light braking whose braking pressure is below a first brake pressure threshold, hard braking whose braking pressure is above a second brake pressure threshold, on-ramp acceleration, passing, cruising at a constant speed, front vehicle cut-in, or a turning whose angular velocity exceeds an angular velocity threshold.

9. A method for training an uncertainty model, the method comprising:
obtaining sample driving event data relating to sample events, each of the sample events belonging to one of a plurality of driving scenarios; and
generating the uncertainty model by machine learning using the sample driving event data based on a multivariate probability prediction algorithm, wherein the uncertainty model is configured to predict uncertainty information that relates to a deviation of an operation of a vehicle according to an intended control instruction from an intended operation of the vehicle according to planning information, the intended control instruction being determined based on the planning information.

10. The method of claim 9, wherein:
the sample driving event data comprises first training data sets of first sample events belonging to a first driving scenario and second training data sets of second sample events belong to a second driving scenario, and
the sample driving event data are balanced such that a first sample event count of the first sample events is in a same order as a second sample event count of the second sample events.

11. The method of claim 10, wherein obtaining the sample driving event data comprises:
retrieving candidate sample driving event data of candidate sample events;
identifying at least a portion of the candidate sample events as belonging to one of the plurality of driving scenarios based on respective candidate sample driving event data of each of the candidate sample events; and
compiling the sample driving event data based on a sample event count of candidate sample events in each of the plurality of driving scenarios such that the sample driving event data are balanced.

12. The method of claim 10, wherein the plurality of driving scenarios comprises at least one of light braking whose braking pressure is below a first brake pressure threshold, hard braking whose braking pressure is above a second brake pressure threshold, on-ramp acceleration, passing, cruising at a constant speed whose acceleration is below an acceleration threshold, front vehicle cut-in, or a turning whose angular velocity exceeds an angular velocity threshold.

13. The method of claim 12, wherein identifying at least a portion of a candidate sample events as belonging to one of the plurality of driving scenarios comprises:
for each of the candidate sample events, comparing candidate sample driving event data with at least one of the first brake pressure threshold, the second brake pressure threshold, the acceleration threshold, or the angular velocity threshold; and
identifying the at least a portion of the candidate sample events as belonging to one of the plurality of driving scenarios based on a result of the comparison.

14. A system for operating a vehicle, comprising:
a mission planner configured to provide planning information of the vehicle over a prediction horizon;
a model predictive control (MPC) controller coupled to the mission planner and configured to perform steps including:
obtaining, from the mission planner, the planning information relating to an intended operation of the vehicle over the prediction horizon;
inputting the planning information into an uncertainty model to determine uncertainty information, wherein:
the uncertainty model is trained using sample driving event data based on a multivariate probability prediction algorithm; and
the uncertainty model is configured to predict the uncertainty information that relates to a deviation of an operation of the vehicle according to an intended control instruction from the intended operation, the intended control instruction being determined based on the planning information; and
generating a control instruction based on the planning information and the uncertainty information; and
a vehicle control interface coupled to the MPC controller to obtain the control instruction and configured to cause the vehicle to operate based on the control instruction.

15. The system of claim 14, wherein the prediction horizon is at least 2 seconds.

16. The system of claim 14, wherein the MPC controller is configured to complete the determination of the uncertainty information and the generation of the control instruction with respect to the prediction horizon within less than 1 second.

17. The system of claim 14, further comprising a perception module configured to acquire environmental information of an environment, wherein the mission planner is configured to generate the planning information based on the environmental information.

18. The system of claim 17, wherein the MPC controller is further configured to input the environmental information into the uncertainty model to determine the uncertainty information.

19. The system of claim 14, wherein the MPC controller is further configured to input context information into the uncertainty model to determine the uncertainty information, the context information relates to a state of the vehicle during the operation of the vehicle.

20. The system of claim 14, wherein:
the planning information and the intended operation relate to a plurality of operation parameters of the vehicle; and
the uncertainty model comprises a plurality of component uncertainty predictors each of which is configured to predict a deviation component of the uncertainty information for one of the plurality of operation parameters.
